(19) United States
(12) Patent Application Publication
(10) Pub. No.: US 2019/0158816 A1
(43) Pub. Date: May 23, 2019

(54) IMAGE DISPLAY DEVICE

(71) Applicant: Mitsubishi Electric Corporation, Tokyo (JP)

(72) Inventor: Osamu MIYAKAWA, Kumamoto (JP)

(73) Assignee: Mitsubishi Electric Corporation, Tokyo (JP)

(21) Appl. No.: 16/180,102

(22) Filed: Nov. 5, 2018

(30) Foreign Application Priority Data
Nov. 21, 2017 (JP) 2017-223522

(51) Int. Cl. H04N 13/315; H04N 13/376; H04N 13/15; H04N 13/349; G02B 27/22

(52) U.S. Cl. CPC H04N 13/315; H04N 13/376; G02B 27/2214; H04N 13/349; H04N 13/15

(57) ABSTRACT

A first transparent substrate of a parallax barrier shutter panel includes, in a display area, lower-layer transparent electrodes disposed below an interlayer insulation film and upper-layer transparent electrodes disposed on the interlayer insulation film as vertically extending first transparent electrodes. The first transparent substrate includes, in an input-side connection area adjacent to the display area, a wire for inputting a barrier control signal that is output from a drive IC into the first transparent electrodes. The first transparent substrate includes, in a counter-input-side connection area adjacent to the display area on an opposite side to the input-side connection area with respect to the display area, a common wire for connecting first transparent electrodes that receive input of the same barrier control signal.

### BACKGROUND OF THE INVENTION

### Field of the Invention

The present invention relates to a naked eye stereoscopic image display device or a dual-screen display device of a parallax barrier type.

### Description of the Background Art

Hitherto, a naked-eye stereoscopic image display device that allows stereoscopic view without the need of special eyeglasses has been proposed. For example, Japanese Patent Application Laid-Open No. 3-119889 (1991) discloses a stereoscopic image display device. The stereoscopic image display device includes barrier generating means for generating parallax barrier stripes through electronic control using a transmission display element, a display screen disposed behind and away from a position of generating the parallax barrier stripes, and image display means for outputting and displaying a multi-directional image onto the display screen, the multi-directional image including strips for a left image and a right image that are alternately arrayed correspondingly to the parallax barrier stripes during stereoscopic image display.

With the stereoscopic image display device in Japanese Patent Application Laid-Open No. 3-119889 (1991), the parallax barrier stripes are electronically generated, and the shape (number, width, interval of the stripes), the position (phase), the density, or the like of the generated parallax barrier stripes can be freely and variably controlled. Therefore, the stereoscopic image display device can also be used as a two-dimensional image display device. That is, an image display device having both of a stereoscopic image display function and a two-dimensional image display function is achieved.

Further, Japanese Patent Application Laid-Open No. 2001-166259 discloses a naked-eye stereoscopic image display device. The naked-eye stereoscopic image display device includes image display means for alternately disposing and displaying a left-eye image and a right-eye image each having a stripe shape, light-shielding means configured to be capable of moving a position of a light-shielding part that generates a binocular parallax effect by a ¼ pitch of a pitch of the light-shielding part, a sensor that detects a position of a head of an observer, and area-dividing and movement-controlling means for horizontally dividing the light-shielding means into areas and for performing movement control on the light-shielding part of the light-shielding means per divided area in accordance with the position of the head of the observer.

With the stereoscopic image display device in Japanese Patent Application Laid-Open No. 2001-166259, even if the head of the observer is moved to a position shifted from an appropriate viewing position, a right-eye image can he supplied to the right eye of the observer and a left-eye image to the left eye by performing movement control on the light-shielding part and performing display control for controlling a display position of the left-eye image and the right-eye image. With this, the observer can recognize a stereoscopic image at his/her position even if the observer is away from the appropriate viewing position.

However, with the stereoscopic image display devices in Japanese Patent Application Laid-Open No, 3-119889 (1991) and Japanese Patent Application Laid-Open No. 2001-166259, the observer perceives change in luminance in the screen when movement control on the light-shielding part (parallax barrier stripes) aid display control on a left-eye image and a right-eye image are performed in accordance with the motion of the head of the observer. Particularly, frequent switching in the positions of the light-shielding part and of the left-eye image and the right-eye image due to frequent motion of the head of the observer raises a sense of discomfort in the observer.

As a technology to solve such problems, Japanese Patent Application Laid-Open No. 2017-58682 proposes a stereoscopic image display device capable of, even when the observer is moved, continuously having the observer visibly recognize a stereoscopic image while reducing local flickering of luminance that may be visibly recognized as a bright line and a dark line. The stereoscopic image display device in Japanese Patent Application Laid-Open No. 2017-58682 includes a display panel in which a plurality of sub-pixel pairs are horizontally disposed, the plurality of sub-pixel pairs each including two sub-pixels that respectively display right-eye and left-eye images, and a parallax barrier shutter panel including a plurality of sub-apertures capable of being switched between a light-transmission state and a light-shielding state by driving a liquid crystal layer held between two transparent substrates with vertically extending transparent electrodes. The sub-apertures of the parallax barrier shutter panel are horizontally disposed side by side at pitches defined by dividing a reference parallax barrier pitch by N (N is an even number equal to or more than four). The reference parallax barrier pitch is determined on the basis of a predetermined designed observation distance and pitches of the sub-pixel pairs. In the parallax barrier shutter panel, there are a plurality of common drive areas defined by horizontally dividing a display area. The (N·M+N/2) (M is a positive integer) number of transparent electrodes disposed in the common drive area are electrically connected every N number of transparent electrodes. Each of the (N/2) number of transparent electrodes as one group taken out of the N number of transparent electrodes disposed at the end within the common drive area is electrically connected to other M number of transparent electrodes. Further, each of the (N/2) number of transparent electrodes as another group taken out of the N number of transparent electrodes disposed at the end within the common drive area is electrically connected to other (M-1) number of transparent electrodes.

Further, Japanese Patent Application Laid-Open No. 2014-66956 discloses a structure of a parallax barrier shutter panel, in which vertically extending transparent electrodes are provided separately in two layers.

Further, Japanese Patent Application. Laid-Open No: 2015-227991 discloses a structure in which an integrated circuit (IC) that outputs control signals (barrier control signals) for a parallax barrier shutter panel supplies barrier control signals from both ends of transparent electrodes that drive the parallax harrier shutter panel.

In the stereoscopic image display device disclosed in Japanese Patent Application Laid-Open No. 2017-58682, in order to improve display performance during the stereoscopic image display mode, it is effective to increase the value of the above N (dividing number) to increase the number (N·M+N/2) of transparent electrodes to be disposed in the common drive area in the parallax barrier shutter panel. However, Japanese Patent Application Laid-Open No. 2017-58682 does not disclose specific methods for increasing N.

For example, assuming that the pitch of the th-pixel pairs in the display panel is 120 μM, the width of the transparent electrode is 12 μm when. N=10, and the width of the transparent electrode is 8.57 μm when N=14. That is, if N is increased, the width of the transparent electrode, i.e., the width of the sub-aperture, is required to be narrowed. A narrower width of the transparent electrode leads to a higher risk of disconnection in the transparent electrode due to a foreign matter or the like that may be generated during deposition and patterning of the transparent electrode. The barrier control signal is not supplied to a portion beyond a disconnected portion of the transparent electrode once the transparent electrode is disconnected, which may produce a defective panel in which a parallax barrier does not operate correctly. Such a problem also occurs when the pitches of the sub-pixels are reduced for the purpose of achieving higher resolution or downsizing of the stereoscopic image display device,

Further, as in. Japanese Patent Application Laid-Open No. 2015-227991, if the barrier control signal is input into the transparent electrode of the parallax barrier shutter panel from both ends, the barrier control signal can be supplied to the entire transparent electrode even when the transparent electrode is disconnected at one portion. However, in order to employ such a configuration, wiring for the barrier control signals is required to be formed on at least three sides of the panel, which hinders narrowing the frame and downsizing of the panel. Further, if the wiring is extended, influence of static electricity from the periphery of the panel is increased, and a short circuit is therefore prone to occur between wires and between electrodes due to electric discharge inside the panel.

### SUMMARY

The present invention has an object to provide an image display device capable of reducing defectiveness caused by disconnection of a transparent electrode while narrowing the width of a sub-aperture formed in a parallax barrier shutter panel and suppressing increase of a frame area of the parallax barrier shutter panel.

According to the present invention, an image display device includes a display panel, and a parallax barrier shutter panel. In the display panel, a plurality of sub-pixel pairs are horizontally disposed at predetermined pitches. The plurality of sub-pixel pairs each include two sub-pixels that display different images. In the parallax barrier shutter panel, a plurality of sub-apertures are horizontally disposed. The plurality of sub-apertures are capable of being switched between a light-transmission state and a light-shielding state by driving a liquid crystal layer held between a first transparent substrate and a second transparent substrate with a plurality of vertically extending transparent electrodes. The display panel and the parallax barrier shutter panel are disposed in a stacked manner in the image display device. The first transparent substrate of the parallax barrier shutter panel includes, in a display area, a plurality of lower-layer transparent electrodes disposed below an interlayer insulation film and a plurality of upper-layer transparent electrodes disposed on the interlayer insulation film as the plurality of transparent electrodes. The first transparent substrate of the parallax barrier shutter panel includes, in a first area adjacent to the display area, a wire for inputting a barrier control signal that is output from a drive circuit into the plurality of transparent electrodes. The barrier control signal is for controlling the parallax barrier shutter panel. The first transparent substrate of the parallax barrier shutter panel includes, in a second area adjacent to the display area on an opposite side to the first area with respect to the display area, a common wire for connecting transparent electrodes that receive input of the same barrier control signal among the plurality of transparent electrodes.

According to the present invention, the transparent electrodes of the first transparent substrate receive input of the barrier control signals from both ends. Therefore, even if one of the first transparent electrodes is disconnected, the barrier control signals can be supplied to a portion beyond the disconnected portion, thus allowing the parallax barrier to operate correctly. Further, since the transparent electrodes are provided separately as the lower-layer transparent electrodes and the upper-layer transparent electrodes, the pitches of the transparent electrodes can be reduced. With this, the effective width of the sub-opening of the parallax barrier shutter panel can be reduced. Further, it is only necessary that the pattern of the common wires be disposed only on two sides (the first area and the second area) of the first transparent substrate. Therefore, the frame area of the parallax barrier shutter panel can be prevented from being extended.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view illustrating a configuration of an image display device according to an underlying technology.

FIG. 2 is a plan view illustrating an overall configuration of a first transparent substrate of a parallax barrier shutter panel according to the underlying technology.

FIG. 3 is a plan view illustrating sub-pixels of the parallax barrier shutter panel according to the underlying technology.

FIG. 4 is a plan view illustrating an integrated aperture of the parallax harrier shutter panel according to the underlying technology.

FIG. 5 is a plan view illustrating an overall configuration of a first transparent substrate of a parallax barrier shutter panel according to a first preferred embodiment of the present invention.

FIG. 6 is a plan view illustrating an overall configuration of the first transparent substrate of the parallax barrier shutter panel according to the first preferred embodiment of the present invention.

FIG. 7 is a plan view of a display area of the parallax barrier shutter panel according to the first preferred embodiment of the present invention.

FIG. 8 is a plan view of the display area of the parallax barrier shutter panel according to the first preferred embodiment of the present invention.

FIG. 9 is a plan view of a counter-input-side connection portion of the parallax barrier shutter panel according to the first preferred embodiment of the present invention.

FIG. 10 is a cross-sectional view of the counter-input-side connection portion of the parallax barrier shutter panel according to the first preferred embodiment of the present invention (a cross-sectional view taken along the line A-A of FIG. 9).

FIG. 11 is a cross-sectional view of the counter-input-side connection portion of the parallax barrier shutter panel according to the first preferred embodiment of the present invention (a cross-sectional view taken along the line B-B of FIG. 9).

FIG. 12 is a cross-sectional view of the counter-input-side connection portion of the parallax barrier shutter panel according to the first preferred embodiment of the present invention (a cross-sectional view taken along the line C-C of FIG. 9).

FIG. 13 is a plan view illustrating a modification of the counter-input-side connection portion of the parallax barrier shutter panel according to the first preferred embodiment of the present invention.

FIG. 14 is a cross-sectional view illustrating a modification of the counter-input-side connection portion of the parallax barrier shutter panel according to the first preferred embodiment of the present invention (a cross-sectional view taken along the line D-D of FIG. 13).

FIG. 15 is a cross-sectional view illustrating a modification of the counter-input-side connection portion of the parallax barrier shutter panel according to the first preferred embodiment of the present invention (a cross-sectional view taken along the line E-E of FIG. 13).

FIG. 16 is a plan view illustrating an overall configuration of the first transparent substrate of the parallax barrier shutter panel according to a second preferred embodiment of the present invention.

FIG. 17 is a plan view of the counter-input-side connection portion of the parallax barrier shutter panel according to the second preferred embodiment of the present invention.

FIG. 18 is a cross-sectional view of the counter-input-side connection portion of the parallax barrier shutter panel according to the second preferred embodiment of the present invention (a cross-sectional view taken along the line F-F of FIG. 17).

FIG. 19 is a plan view illustrating a modification of the counter-input-side connection portion of the parallax barrier shutter panel according to the second preferred embodiment of the present invention.

FIG. 20 is a cross-sectional view illustrating a modification of the counter-input-side connection portion of the parallax barrier shutter panel according to the second preferred embodiment of the present invention (a cross-sectional view taken along the line G-G of FIG. 19).

FIG. 21 is a plan view illustrating a modification of the counter-input-side connection portion of the parallax barrier shutter panel according to the second preferred embodiment of the present invention.

FIG. 22 is a cross-sectional view illustrating a modification of the counter-input-side connection portion of the parallax barrier shutter panel according to the second preferred embodiment of the present invention (a cross-sectional view taken along the line H-H of FIG. 21).

FIG. 23 is a plan view illustrating an overall configuration of the first transparent substrate of the parallax barrier shutter panel according to a third preferred embodiment of the present invention.

FIG. 24 is a plan view of the counter-input-side connection portion of the parallax barrier shutter panel according to the third preferred embodiment of the present invention.

FIG. 25 is a plan view illustrating the parallax barrier shutter panel according to a fourth preferred embodiment of the present invention.

FIG. 26 is a plan view of the counter-input-side connection portion of the parallax barrier shutter panel according to the fourth preferred embodiment of the present invention.

### DESCRIPTION OF THE PREFERRED EMBODIMENTS

In the following, preferred embodiments of the present invention will be described. First, an underlying technology thereof will be described.

<Underlying Technology>

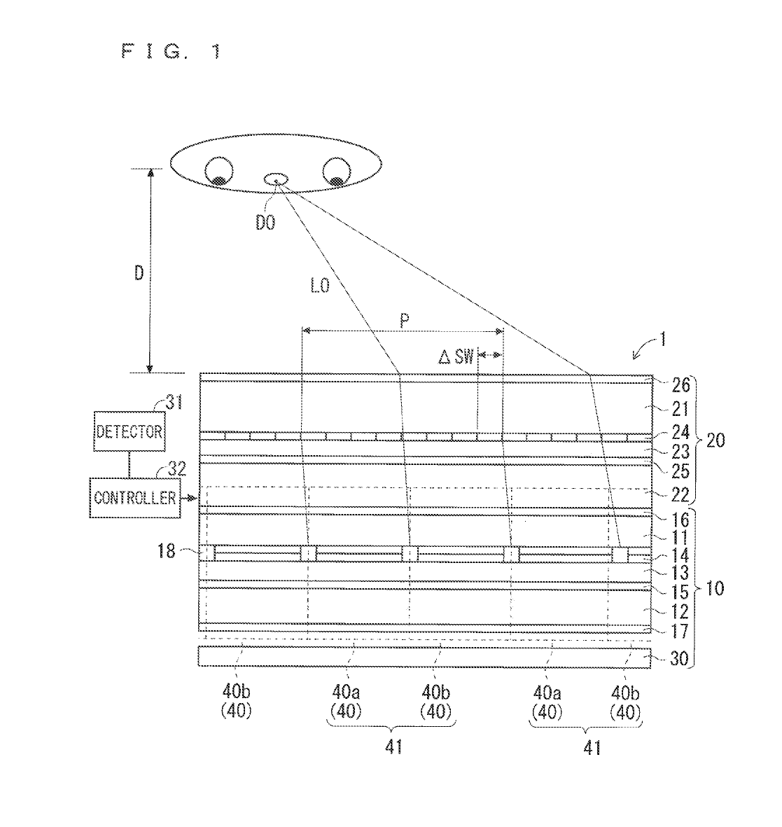

FIG. 1 is a cross-sectional view illustrating a configuration of an image display device 1 according to an underlying technology. The image display device 1 can simultaneously display two images, namely, a right image (a parallax image for the right eye of the observer, or arm image for a first observation direction) and a left image (a parallax image for the left eye of the observer, or an image for a second observation direction). According to the image display device 1, the observer can visibly observe a stereoscopic image with the naked eye without using special eyeglasses, or different images can be displayed in different observation directions. In short, the image display device 1 can be applied to a naked-eye stereoscopic image display device and also to a dual-screen display device (dual-view display device). In the following description, a case where the image display device 1 is used as a naked-eye stereoscopic image display device swill be mainly described.

FIG. 1 illustrates a cross-sectional structure of the image display device 1. Further, as illustrated in FIG. 1, the image display device 1 is connected to a detector 31 that detects the position (motion) of the head of the observer or the like, and to a controller 32 that integrally controls the image display device 1 and the detector 31 based on a detection result of the detector 31, image signals, etc.

Note that, in the description of the underlying technology, the long direction of the drawing sheet of FIG. 1 is referred to as a front-back direction of the image display device 1, the short direction of the drawing sheet of FIG. 1 as a horizontal direction (width direction) of the image display device 1, and the depth direction of the drawing sheet of FIG. 1 as a vertical direction (height direction) of the image display device 1.

As illustrated in FIG. 1, the image display device 1 includes a display panel 10, and a parallax barrier shutter panel 2( )(an optical guiding member) that is disposed at the front (the upper side in FIG. 1) of the display panel 10.

The display panel 10 is a matrix display panel. For example, an organic EL panel, a plasma display panel, or a liquid crystal display panel is applicable as the display panel 10. Note that, if a liquid crystal display panel is applied as the display panel 10, the parallax harrier shutter panel 20 may be disposed at the back (the lower side in FIG. 1) of the display panel 10.

FIG. 1 illustrates an example where a liquid crystal display panel is applied as the display panel 10. Specifically, the display panel 10 includes two transparent substrates 11 and 12, and a liquid crystal layer 13 interposed between the two transparent substrates 11 and 12. A sub-pixel transparent electrode 14 is formed on the transparent substrate 11 on the front side. The sub-pixel transparent electrode 14 is formed into a strip shape (elongated shape a extending in the vertical direction (depth direction of FIG. 1). A counter-transparent electrode 15 is formed on the transparent substrate 12 on the back side. The counter-transparent electrode 15 is formed across the entire surface of the transparent substrate 12. The liquid crystal layer 13 is driven by the sub-pixel transparent electrode 14 and the counter-transparent electrode 15 that interpose the liquid crystal layer 13.

An intermediate polarizing plate 16 is provided in front of the transparent substrate 11, and a back polarizing plate 17 is provided on the back of the transparent substrate 12. Further, a backlight 30 is provided at the back of the hack polarizing plate 17. Further, although not shown, an alignment film for aligning the liquid crystal layer 13 in a certain direction is formed on a surface of each of the transparent substrates 11 and 12 on the liquid crystal layer 13 side.

The configuration of the display panel 10 is not limited to the configuration illustrated in FIG. 1. For example, the sub-pixel transparent electrode 14 is disposed at the front of the counter-transparent electrode 15 in FIG. 1, but conversely, the sub-pixel transparent electrode 14 may be disposed at the back of the counter-transparent electrode 15.

A plurality of sub-pixels 40 are disposed in the display panel 10. Among the sub-pixels 40, sub-pixels 40 that display a right image are hereinafter referred to as “sub-pixels 40a,” and sub-pixels 40 that display a left image as “sub-pixels 40b.” The sub-pixels 40a and the sub-pixels 40b are alternately disposed in the horizontal direction (short direction of FIG.1). A light-shielding wall 18 is provided between the sub-pixel 40a and the sub-pixel 40b. In other words, each of the sub-pixels 40a and 40b is interposed between the light-shielding walls 18.

The width of each of the sub-pixels 40a and 40b is equal or substantially equal. Here, a pair of adjacent sub-pixels 40a and 40b forms a sub-pixel pair 41 that displays two images (a right image and a left image) different on the right and the left. Sub-pixel pairs 41 are arrayed in the display panel 10 in the horizontal direction at regular pitches. Further, the sub-pixel pairs 41 are also arrayed in the vertical direction, not only in the horizontal direction.

In the image display device 1 of FIG. 1, a reference parallax barrier pitch P is defined, which is a horizontal reference pitch corresponding to the width of the sub-pixel pair 41. The reference parallax barrier pitch P is set such that imaginary rays of light LO, which each come from the center of the tight-shielding wall 18 located between the sub-pixel 40a and the sub-pixel 40b that form the sub-pixel pair 41 and pass through the center of the reference parallax barrier pitch P of the corresponding sub-pixel pair 41, converge at a designed visible observation point DO positioned away from the image display device 1 in the front direction by a designed observation distance D. Note that, for the sake of facilitating the description, the reference parallax barrier pitch P is herein regarded as the sum of the width of the sub-pixel 40a and the width of the sub-pixel 40b. Optimization of the designed observation distance D is not relevant herein, and therefore the description thereof is omitted.

The parallax barrier shutter panel 20 includes two transparent substrates 21 and 22, and a liquid crystal layer 23 held between the two transparent substrates 21 and 23. The transparent substrate 21 that is located on the front side is hereinafter referred to as a “first transparent substrate 21,” and the transparent substrate 22 that is located on the back side as a “second transparent substrate 22.”

A plurality of first transparent electrodes 24 having a strip shape that extends in the vertical direction are formed on a surface of the first transparent substrate 21 on the liquid crystal layer 23 side. Each individual first transparent electrode 24 corresponds to a portion obtained by dividing a transparent electrode within a reference parallax barrier pitch P of a sub-pixel pair 41 into an even number (here, eight). That is, an even number of (here, eight) first transparent electrodes 24 are arrayed within the reference parallax barrier pitch P.

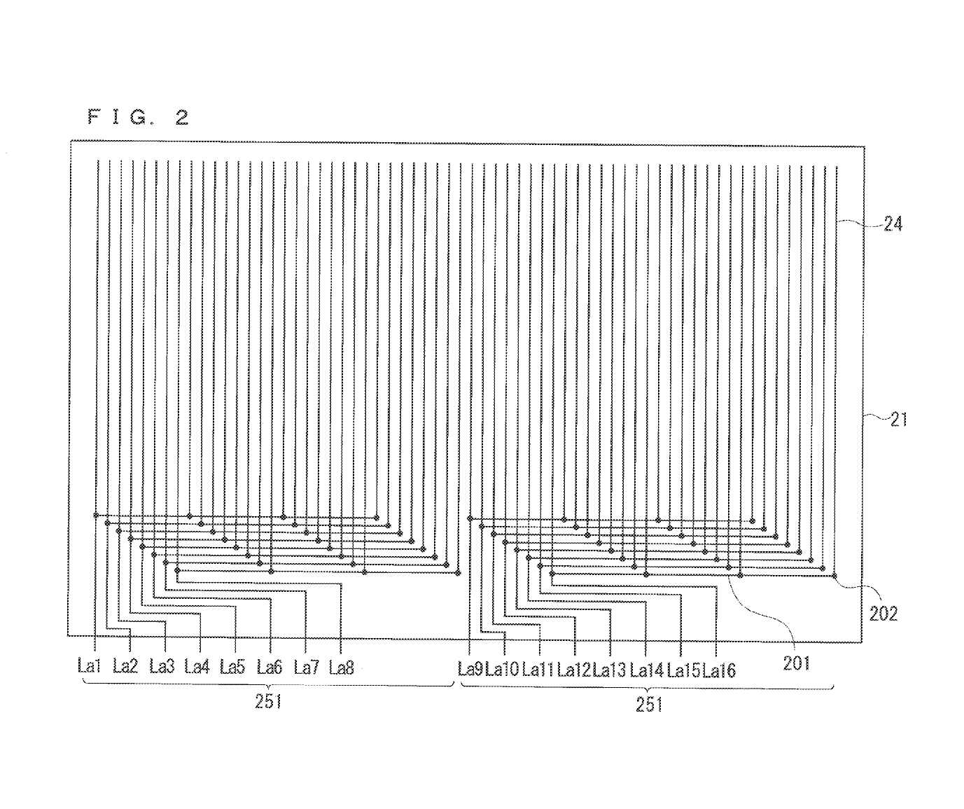

FIG. 2 is a diagram illustrating a configuration of the first transparent substrate 21 according to the underlying technology, specifically illustrating a connection relationship of the plurality of first transparent electrodes 24 disposed on the first transparent substrate 21. In FIG. 2, two common drive areas 251 on the first transparent substrate 21 are illustrated. One common drive area 251 includes four reference parallax barrier pitches P. Here, since eight first transparent electrodes 24 are provided within one reference parallax barrier pitch P, thirty-two first transparent electrodes 24 are disposed in one common drive area 251.

The plurality of first transparent electrodes 24 illustrated in FIG. 2 receive input of barrier control signals La1 to La16. Further, in the common drive area 251, a plurality of (four in FIG. 2) first transparent electrodes 24 receive input of the same common barrier control signal. Therefore, in the first transparent substrate 21, common wires 201 each for connecting the first transparent electrodes 24 that receive input of the same barrier control signal are provided. Further, the first transparent electrodes 24 and the common wires 201 are connected by respective connection portions 202. Note that, unless otherwise particularly noted, the first transparent electrodes 24 that are not connected via the common wire 201 are electrically insulated from each other.

Referring back to FIG. 1, a second transparent electrode 25 that extends in the horizontal direction is formed on a surface of the second transparent substrate 22 on the liquid crystal layer 23 side. A plurality of second transparent electrodes 25 may be disposed side by side in the vertical action (depth direction of FIG. 1) at vertical pitches of the sub-pixel pairs 41, or a second transparent electrode 25 may be disposed across the entire surface of the second transparent substrate 22. Here, the second transparent electrode 25 is formed across the entire surface of the second transparent substrate 22.

The first transparent electrode 24 and the second transparent electrode 25 apply an electric field to the liquid crystal layer 23, to thereby drive the liquid crystal layer 23, As a driving mode of the liquid crystal layer 23, Twisted Nematic (TN), Super-Twisted Nematic (STN), In-Plane Switching, Optically Compensated Bend (OCB), or the like can be used.

A display-surface polarizing plate 26 is provided in front of the first transparent substrate 21. Further, a polarizing plate is also provided on the back of the second transparent substrate 22. Here, however, the intermediate polarizing plate 16 of the display panel 10 serves as the polarizing plate. The first transparent substrate 21 is disposed at the front of the second transparent substrate 22 in FIG. 1, but conversely, the first transparent substrate 21 may be disposed at the back of the second transparent substrate 22.

Incidentally, a voltage is selectively applied to each of the first transparent electrode 24 and the second transparent electrode 25. Accordingly, the parallax barrier shutter panel 20 can be switched between a light-transmission state and a light-shielding state in the unit of the width of the first transparent electrode 24. In the following description, an optical aperture in the parallax barrier shutter panel 20 that can be switched between a light-transmission state and a light-shielding state in the unit of the first transparent electrode 24 by electrical control is referred to as a “sub-aperture.”

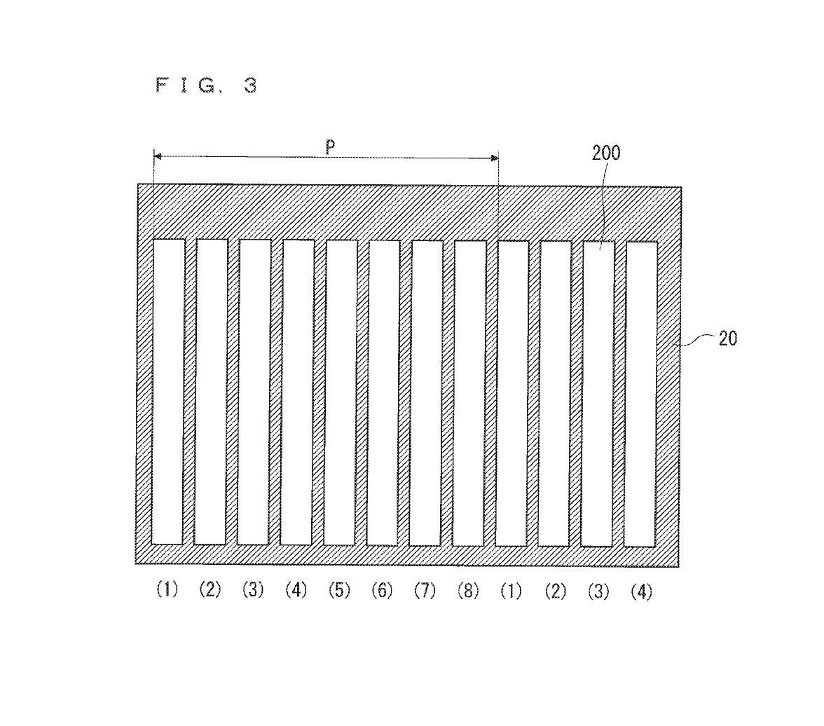

Sub-apertures are formed at positions corresponding to the respective plurality of first transparent electrodes 24. Since eight first transparent electrodes 24 are horizontally arrayed within the reference parallax barrier pitch P in the parallax barrier shutter panel 20 of the image display device 1 of FIG. 1, eight sub-apertures 200 are horizontally arrayed within the reference parallax barrier pitch Pas in FIG. 3.

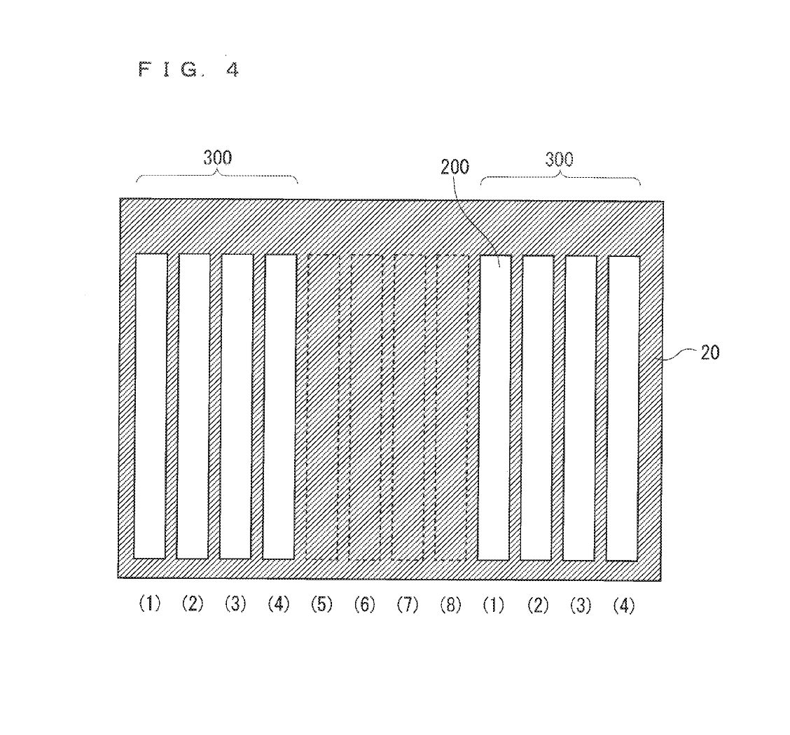

Although all of the sub-apertures 200 are in a light-transmission state (aperture-open state) in FIG. 3, each parallax barrier shutter panel 20 can be switched between a light-transmission state and a light-shielding state by controlling a voltage for the first transparent electrode 24. For example, FIG. 4 illustrates an example where a. half (four, (5) to (8)) of sub-apertures 200 out of a plurality of (eight, (1) to (8)) sub-apertures 200 within the reference parallax barrier pitch P are in a light-shielding state. A group of sub-apertures 200 that are in a light-transmission state within the reference parallax barrier pitch P is hereinafter referred to as an “integrated aperture 300.” The integrated aperture 300 (sub-apertures 200 in a light-transmission state) serves to guide light emitted from the sub-pixel 40b for a left image and light emitted from the sub-pixel 40a for a right image into directions different from each other. Although the integrated aperture 300 that is made up of four sub-apertures 200 in a light-transmission state is formed on the left half of the reference parallax barrier pitch P in FIG. 4, the position of the integrated aperture 300 can be changed by changing sub-apertures 200 to be brought into a light-transmission state.

Next, operation of the image display device 1 will be briefly described. The detector 31 connected to the image display device 1 detects the position (motion) of the observer. The controller 32 controls the state (light-transmission state/light-shielding state) of each sub-aperture 200 of the parallax barrier strutter panel 20 based on a detection result of the detector 31, thereby controlling the position of the integrated aperture 300. That is, when the position of the observer moves right and left, the controller 32 correspondingly moves the integrated aperture 300 in the horizontal direction. As a result, the observer can continue viewing a stereoscopic image even if the observer moves right and left.

In such an image display device 1 as described above, increase in the number of sub-apertures 200 to be provided within the reference parallax barrier pitch P enables finer control of positions where stereoscopic images can be displayed. In order to achieve this, however, a large number of first transparent electrodes 24 need to be provided within the reference parallax barrier pitch P, which requires narrowing the width of the first transparent electrodes 24. However, a narrower width of the first transparent electrodes 24 leads to a higher risk of occurrence of disconnection due to pattern failure of the first transparent electrodes 24. If the first transparent electrode 24 is disconnected, the parallax barrier does not correctly function in an area beyond the disconnected portion.

### First Preferred Embodiment

The overall configuration of an image display device 1 according to a first preferred embodiment of the present invention is similar to that of FIG. 1. Although not shown in FIG. 1, the image display device 1 of the first preferred embodiment has a different feature from the above underlying technology in the structure of a first transparent substrate 21 of a parallax barrier shutter panel 20. Therefore, the configuration of the first transparent substrate 21 in particular will be described in this preferred embodiment. The configuration of a second transparent substrate 22 may be the same as that of the underlying technology. Here, a second transparent electrode 25 is formed across the entire surface of the second transparent substrate 22.

Further, in this preferred embodiment, the number of sub-apertures 200, i.e., the number of first transparent electrodes 24, to be provided within a reference parallax barrier pitch P is eight, Note that, the number of sub-apertures 200 to be provided within a reference parallax barrier pitch P is not limited to eight, as long as a plurality of sub-apertures 200 are provided.

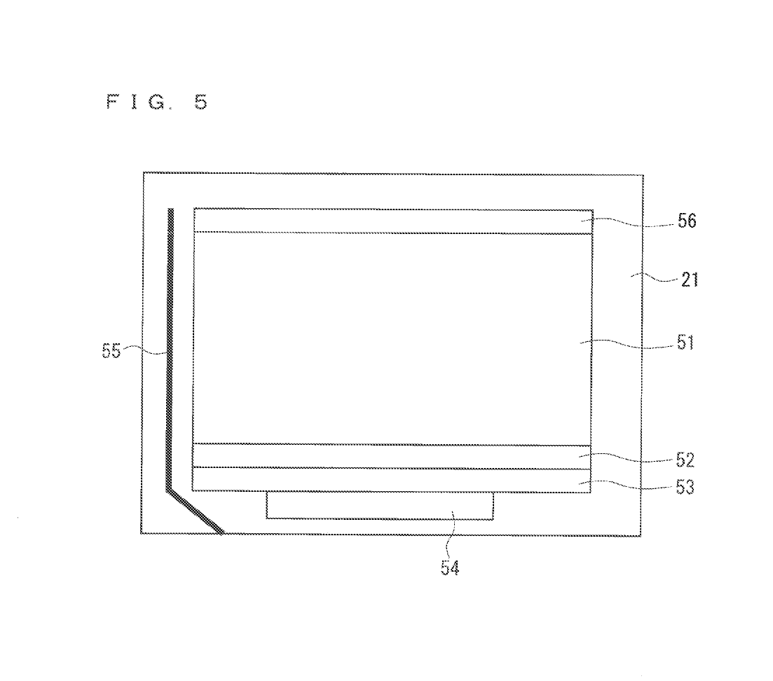

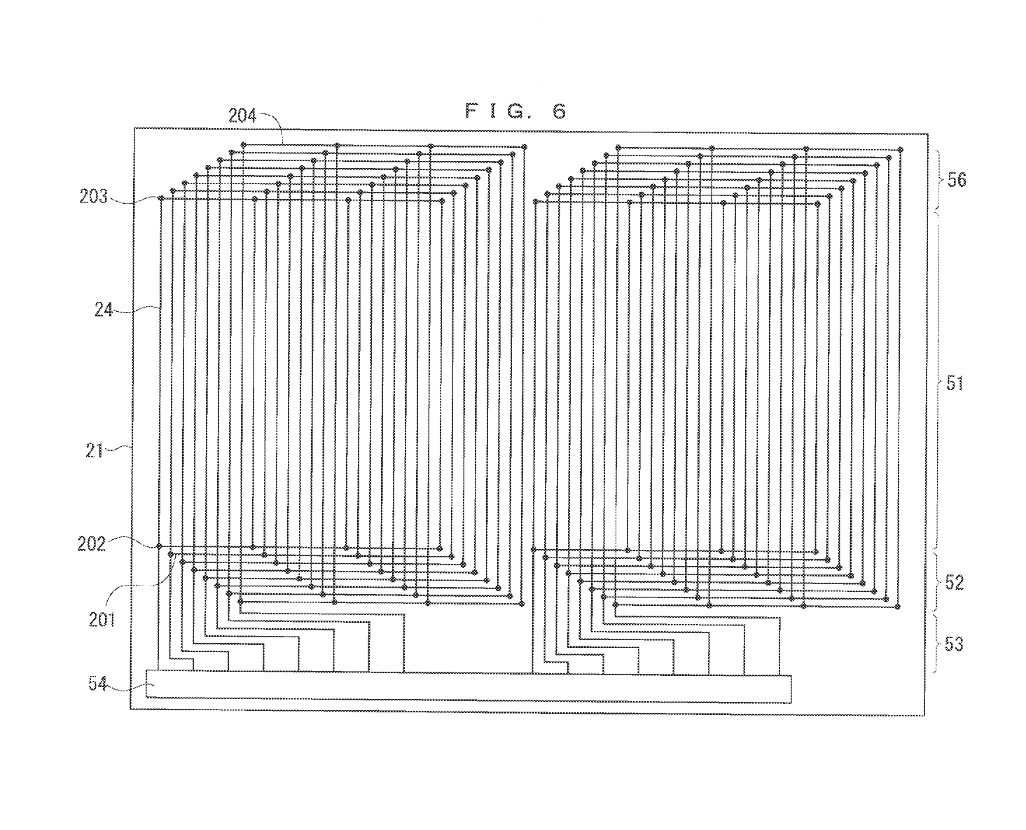

FIG. 5 and FIG. 6 are each a plan view illustrating an overall configuration of the first transparent substrate 21 of the parallax barrier shutter panel 20. FIG. 6 illustrates a connection relationship of wires provided in respective areas illustrated in FIG. 5.

As in FIG. 5, a display area 51 is defined at the center of the first transparent substrate 21. Further, as in FIG. 6, first transparent electrodes 24 having a strip shape that form sub-apertures 200 are arrayed side by side in the display area 51.

Adjacently to the display area Si, an input-side connection area 52 (a first area) is provided, which is an area for connecting the first transparent electrodes 24 to a metal wire. The metal wire in the input-side connection area 52 is a wire for allowing barrier control signals from a drive integrated circuit (IC) 54 to be input into the first transparent electrodes 24. The drive IC 54 is a drive circuit that outputs barrier control signals for controlling the parallax barrier shutter panel 20. Further, in the input-side connection area 52, common wires 201 each for connecting the first transparent electrodes 24 that receive input of the same barrier control signal arc provided. The first transparent electrodes 24 and the common wires 201 are connected by respective connection portions 202.

Further, on the outer side of the input-side connection area 52, a wire area 53 is provided, which is an area for connecting the metal wire in the input-side connection area 52 to the drive IC 54. That is, the first transparent electrodes 24 are electrically connected to the drive IC 54 via the metal wire in the input-side connection area 52 and the wire area 53. With this, a signal (voltage) output by the drive IC 54 can be applied to the first transparent electrodes 24 in the display area 51. Note that, the drive IC 54 receives input of a signal for controlling the position of the integrated aperture 300 from the outside (e.g. the controller 32 illustrated in FIG. 1).

A counter-input-side connection area 56 (a second area) is provided adjacently to the display area 51 on the opposite side (the upper side in FIG. 5) to the input-side connection area 52 with respect to the display area 51. The counter-input-side connection area 56 is an area for connecting the first transparent electrodes 24 that receive input of the same barrier control signal. In the counter-input-side connection area 56, common wires 204 each for connecting the first transparent electrodes 24 that receive input of the same barrier control signal are provided. The first transparent electrodes 24 and the common wires 204 are connected by respective connection portions 203.

In this manner, in the first transparent substrate 21 according to the first preferred embodiment, the first transparent electrodes 24 that receive input of the same barrier control signal are connected by both of the common wire 201 in the input-side connection area 52 and the common wire 204 in the counter-input-side connection area 56. That is, the first transparent electrodes 24 that receive input of the same barrier control signal are connected one another at their both ends.

Further, as illustrated in FIG. 5, a counter-substrate connection electrode 55 (not shown in FIG. 6) is disposed on the outer side of the display area 51. The counter-substrate connection electrode 55 is for supplying a voltage to the second transparent electrode 25 of the second transparent substrate 22 when the second transparent substrate 22 is disposed so as to face the first transparent substrate 21. With this, a desired voltage can be applied between the second transparent substrate 22 and the first transparent substrate 21, thus enabling control of the state (light-transmission state/light-shielding state) of each sub-aperture 200. The counter-substrate connection electrode 55 is disposed in only one side of the first transparent substrate 21 in FIG. 5, but may be disposed more extensively. Further, only a part of the counter--substrate connection electrode 55 may be electrically connected to the second transparent electrode 25.

Note that, in this preferred embodiment, various wires illustrated in FIG. 6 are formed on a surface of the first transparent substrate 21 on the liquid crystal layer 23 side. That is, components such as the first transparent electrode 24, the common wire 201, and the common wire 204 are formed between the first transparent substrate 21 and the second transparent substrate 22.

Here, an area outside of the display area 51 is referred to as a “frame area.” An area where the input-side connection area 52, the wire area 53, the counter-input-side connection area 56, the drive IC 54, and the counter-substrate connection electrode 55 are disposed is included in the frame area.

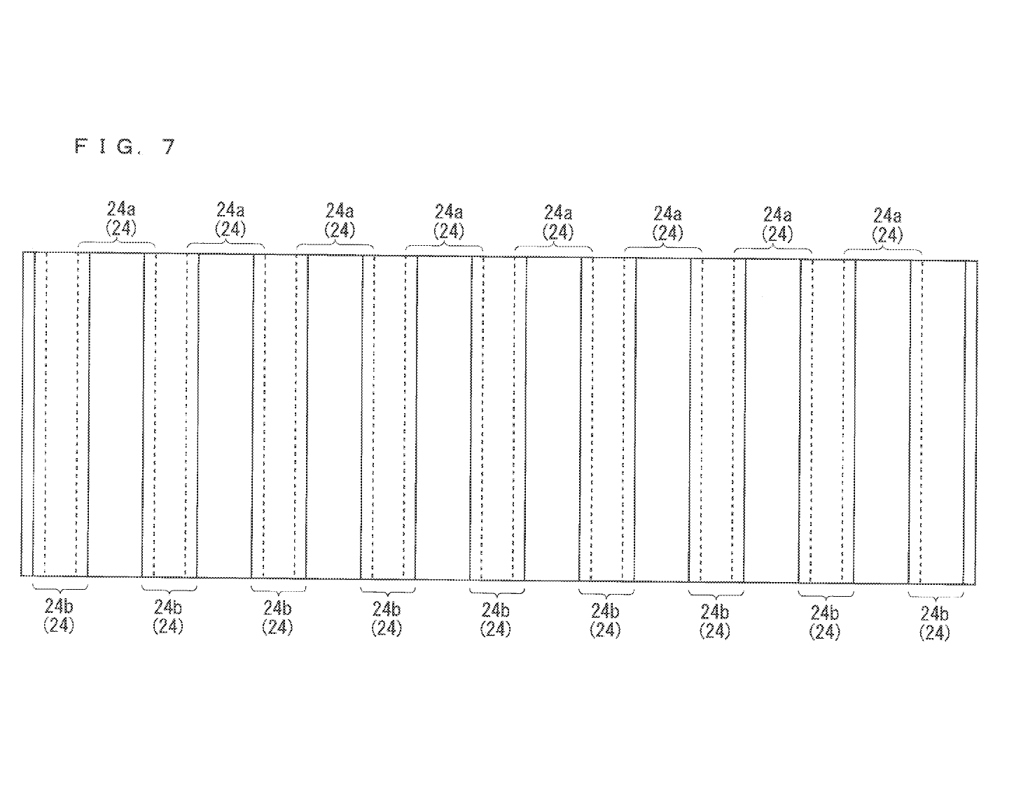

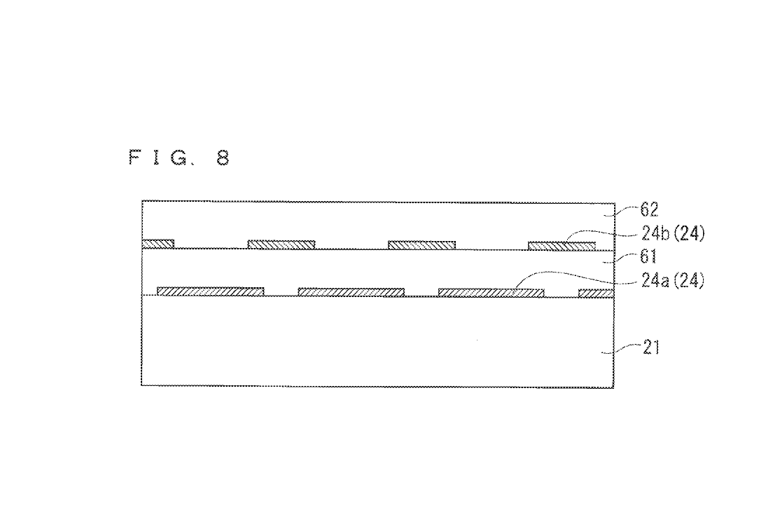

FIG. 7 is a partial enlarged plan view of the display area 51 of the first transparent substrate 21. FIG. 8 is a partial horizontal cross-sectional view of an area illustrated in FIG. 7. As illustrated in FIG. 7 and FIG. 8, the plurality of first transparent electrodes 24 are provided separately in two layers above the first transparent substrate 21. That is, in the parallax barrier shutter panel 20 according to the first preferred embodiment, lower-layer transparent electrodes 24a and upper-layer transparent electrodes 24b formed in different layers are provided as the first transparent electrodes 24.

The lower-layer transparent electrodes 24a are formed on the first transparent substrate 21, and an interlayer insulation film 61 is formed on the lower-layer transparent electrodes 24a. The upper-layer transparent electrodes 24b are formed on the interlayer insulation film 61, and a protective insulation film 62 is formed on the upper-layer transparent electrodes 24b. As in above, the lower-layer transparent electrodes 24a are disposed below the interlayer insulation film 61, and the upper-layer transparent electrodes 24b are disposed on the interlayer insulation film 61. Note that, the protective insulation film 62 on the upper-layer transparent electrodes 24b may be omitted.

Although not shown, an alignment film is formed on the topmost layer a surface on the liquid crystal layer 23 side) of the first transparent substrate 21. Further, an alignment film is also provided on the topmost layer of the second transparent substrate 22.

In FIG. 7 and FIG. 8, ends of the lower-layer transparent electrodes 24a and ends of the upper-layer transparent electrodes 24b overlap one another, and no gap is present between the lower-layer transparent electrodes 24a and the upper-layer transparent electrodes 24b in plan view. With this, gaps between the sub-apertures 200 formed in the parallax barrier shutter panel 20 can he eliminated. Note that, if the width of each of the lower-layer transparent electrodes 24a and the upper-layer transparent electrodes 24b can be narrowed, both of the lower-layer transparent electrodes 24a and the upper-layer transparent electrodes 24b may be disposed so as not to overlap one another.

It is desirable that the width of the sub-apertures 200 controlled by the lower-layer transparent electrodes 24a and the width of the sub--apertures 200 controlled by the upper-layer transparent electrodes 24b be equal. In order to achieve this, it is only necessary that the width of the liquid crystal layer 23 driven by the lower-layer transparent electrodes 24a and the width of the liquid crystal layer 23 driven by the upper-layer transparent electrodes 24b be equal. The width of an area where an electric field is generated between the lower-layer transparent electrodes 24a and the second transparent electrode 25 is determined by the interval of the upper-layer transparent electrodes 24b; however, the distance from the second transparent electrode 25 to the lower-layer transparent electrodes 24a is larger than the distance from the second transparent electrode 25 to the upper-layer transparent electrodes 24b. Therefore, narrowing the width of the upper-layer transparent electrodes 24b so as to be slightly smaller than the interval of the upper-layer transparent electrodes 24b can substantially equalize the width of the liquid crystal layer 23 driven by the lower-layer transparent electrodes 24a to the width of the liquid crystal layer 23 driven by the upper-layer transparent electrodes 24b.

As in above, if the first transparent electrodes 24 are disposed separately as the lower-layer transparent electrodes 24a and the upper-layer transparent electrodes 24b, the first transparent electrodes 24 can be disposed so as to be partially overlap one another. With this, the effective width of each first transparent electrode 24 can be reduced, and thus the width of the sub-aperture 200 can be narrowed.

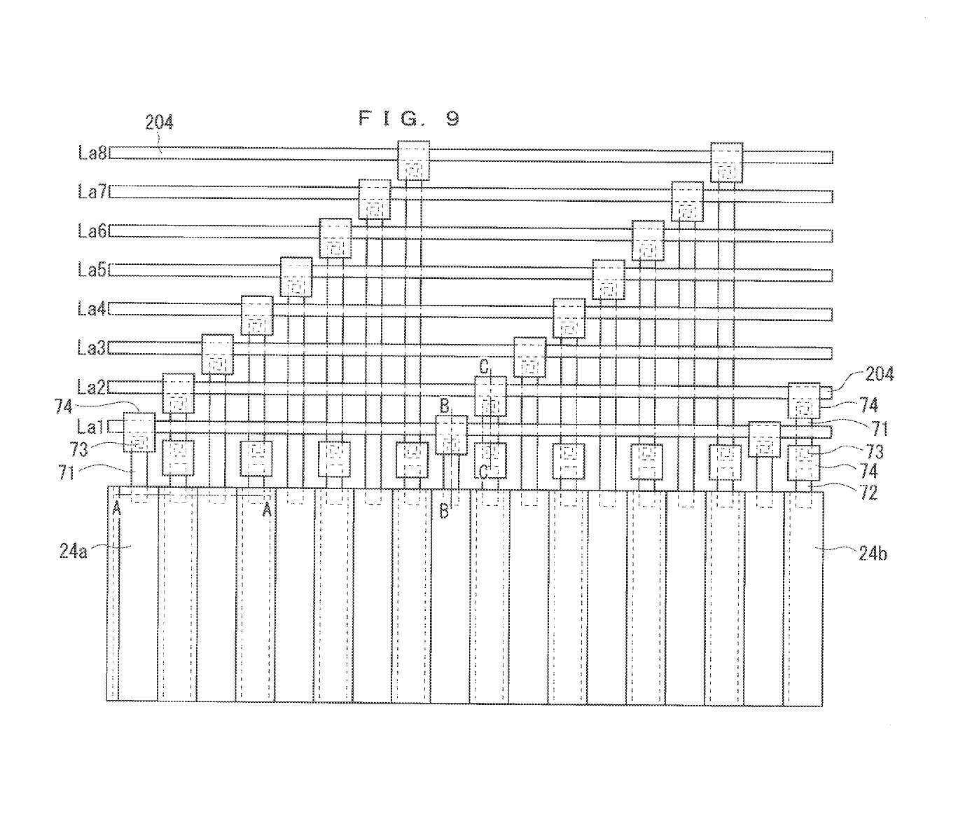

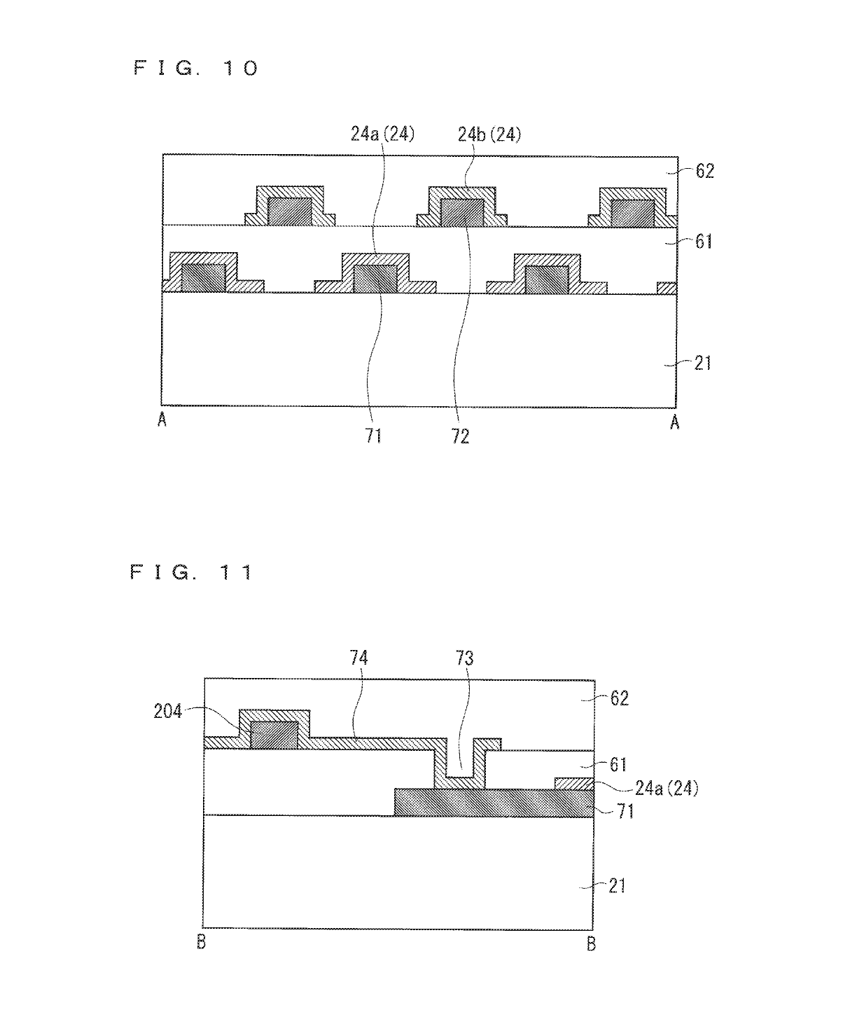

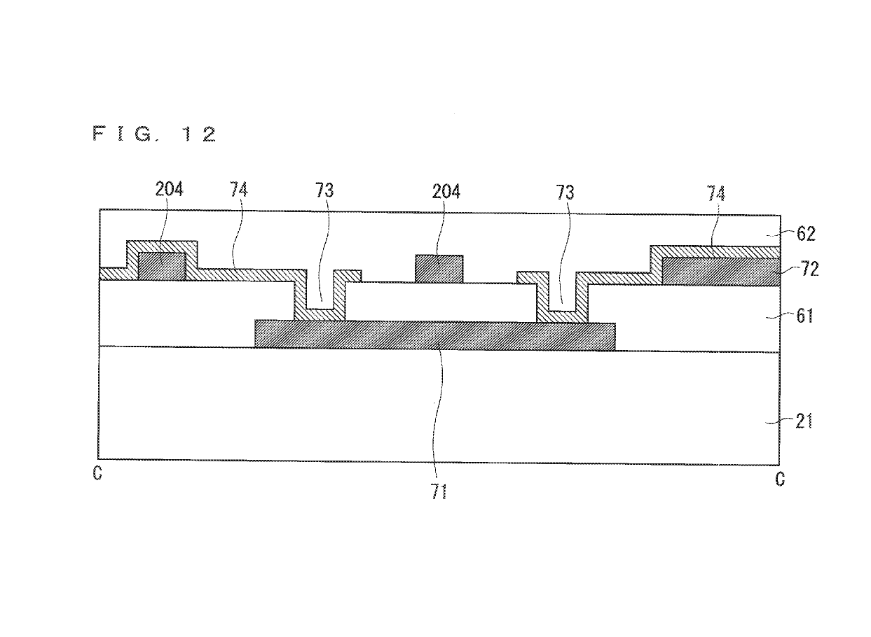

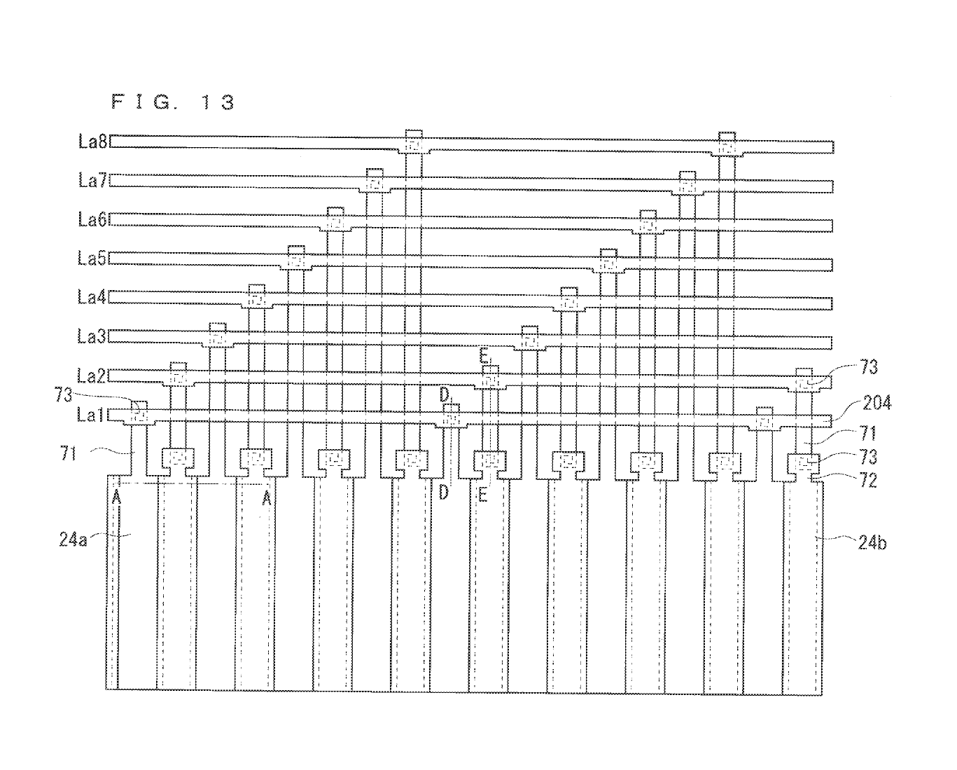

Next, structure of the counter-input-side connection area 56 of the first transparent substrate 21 will be described. FIG. 9 is a partial enlarged plan view of the counter-input-side connection area 56. Further, FIG. 10, FIG. 11, and FIG. 12 arc cross-sectional views taken along the line A-A, the line B-B, and the line C-C illustrated in FIG. 9, respectively. Note that, the lower side of FIG. 9 is connected to the display area 51.

As illustrated in FIG. 9 and FIG. 10, the lower-layer transparent electrodes 24a led out from the display area 51 into the counter-input-side connection area 56 are directly connected to lower-layer wires 71 that arc metal wires formed on the first transparent substrate 21 (below the interlayer insulation film 61). Further, the upper-layer transparent electrodes 24b led out from the display area 51 into the counter-input-side connection area 56 are directly connected to upper-layer wires 72 that are metal wires formed on the interlayer insulation film 61 (below the protective insulation film 62). Note that, the lower-layer wires 71 and the upper-layer wires 72 that are respectively electrically connected to the lower-layer transparent electrodes 24a and the upper-layer transparent electrodes 24b form a part of the first transparent electrodes 24 in FIG. 6.

In this manner, contact holes are not used for the electrical connection between the lower-layer transparent electrode 24a and the lower-layer wire 71 and the electrical connection between the upper-layer transparent electrode 24b and the upper-layer wire 72. It is possible to use contact holes for such connections. In such a case, however, the horizontal width of an area for forming the contact holes needs to be amply secured depending on the precision in size of the contact holes and the precision in positioning of each of the layers. This makes it difficult to reduce the pitches of the lower-layer transparent electrodes 24a and the pitches of the upper-layer transparent electrodes 24b, raising fears that the horizontal width of the input-side connection area 52 may be extended. Further, the horizontal width of the input-side connection area 52 can be prevented from being extended by vertically alternately (in a zigzag manner) disposing the areas for forming the contact holes. This, however, is not preferable because the vertical width may be extended.

Owing to such a configuration as in this preferred embodiment in which contact holes are not used for the connection between the lover-layer transparent electrodes 24a and the lower-layer wires 71 and the connection between the upper-layer transparent electrodes 24b and the upper-layer wires 72, the pitches of the lower-layer transparent electrodes 24a and the pitches of the upper-layer transparent electrodes 24b can be reduced. This can contribute to downsizing and improvement in the degree of freedom in designing of the image display device 1.

Now, one example is given of width and interval for the lower-layer transparent electrode 24a, the upper-layer transparent electrode 24b, the lower-layer wire 71, and the upper-layer wire 72. For example, the width of the upper-layer transparent electrode 24b may be 8.4 μm; the interval between the upper-layer transparent electrodes 24b, 8.6 μm; the width of the upper-layer wire 72, 4.0 μm, the width of the lower-layer transparent electrode 24a, 12.4 μm; and the width of the lower-layer wire 71, 4.0 μm. In this case, assuming that the number of common drive electrodes (the number of the first transparent electrodes 24 within the reference parallax barrier pitch P) is fourteen, the reference parallax barrier pitch P is 119 μm and thus the number of common drive electrodes can be increased even when the reference parallax barrier pitch P is small.

In the first preferred embodiment, the number of the first transparent electrodes 24 (the lower-layer transparent electrodes 24a and the upper-layer transparent electrodes 24b) provided within the reference parallax barrier pitch P is eight, and the first transparent electrodes 24 are driven in common (electrically in common) every eight first transparent electrodes 24. The electrically common first transparent electrodes 24 receive input of the same barrier control signal. Thus, in this preferred embodiment, the first transparent electrodes 24 that receive input of the same barrier control signal are disposed every eight first transparent electrodes 24.

As in FIG. 9, electrically common lower-layer transparent electrodes 24a or upper-layer transparent electrodes 24b are electrically connected to one common wire 204 extending in the horizontal direction. The common wires 204 are formed of a metal film in the same layer as the, upper-layer wires 72, and are provided for their respective barrier control signals. That is, the number of the common wires 204 to be provided in a single common drive area is equal to the number of the barrier control signals. Further, the lower-layer transparent electrodes 24a or the upper-layer transparent electrodes 24b that are connected to different common wires 204 receive input of different barrier control signals.

As illustrated in FIG. 11 and FIG. 12, the lower-layer transparent electrodes 24a and the lower-layer wires 71 are formed below the interlayer insulation film 61, and the upper-layer transparent electrodes 24b, the upper-layer wires 72, and the common wires 204 are formed on the interlayer insulation film 61. The electrical connection therebetween is achieved through contact holes 73 formed in the interlayer insulation film 61. Specifically, the contact holes 73 are formed in the interlayer insulation film 61 so as to reach upper surfaces of the lower-layer wires 71 or the lower-layer transparent electrodes 24a. Connection wires 74 are formed so as to connect, through the contact holes 73, wires on the interlayer insulation film 61 (the upper-layer wires 72 or the common wires 204) and wires below the interlayer insulation film 61 (the lower-layer wires 71 or the lower-layer transparent electrodes 24a). The connection wires 74 are formed of a transparent conductive film in the same layer as the upper-layer transparent electrodes 24b. The contact holes 73 and the connection wires 74 illustrated in FIG. 11 and FIG. 12 that connect the lower-layer wires 71 and the common wires 204 (corresponding to the common wires 201 of FIG. 6) correspond to the connection portions 203 illustrated in FIG. 6.

Note that, although description will be omitted as for the input-side connection area 52 and the wire area 53 illustrated in FIG. 5 and FIG. 6, the input-side connection area 52 and the wire area 53 can be formed similarly to the counter-input-side connection area 56. That is, the input-side connection area 52 and the wire area 53 can be formed using lower-layer wires formed on the first transparent substrate 21, upper-layer wires formed on the interlayer insulation film 61, contact holes formed in the interlayer insulation film 61, connection wires formed of a transparent conductive film in the same layer as the upper-layer transparent electrodes 24b, and common wires (the common wires 201 illustrated in FIG. 6) formed of a metal film in the same layer as the upper-layer wires 72. Therefore, the input-side connection area 52, the wire area 53, and the counter-input-side connection area 56 can be formed simultaneously through the same manufacturing process.

In the parallax barrier shutter panel 20 according to the first preferred embodiment, the first transparent electrodes 24 of the first transparent substrate 21 (the lower-layer transparent electrodes 24a and the upper-layer transparent electrodes 24b) receive input of barrier control signals from both ends. Therefore, even if one of the first transparent electrodes 24 is disconnected, barrier control signals can be supplied to a portion beyond the disconnected portion, thus allowing the parallax barrier to operate correctly.

Further, since the first transparent electrodes 24 are provided separately as the lower-layer transparent electrodes 24a and the upper-layer transparent electrodes 24b, the pitches of the first transparent electrodes 24 can be reduced. This can contribute to narrowing the effective width of the sub-aperture of the parallax barrier shutter panel 20, as well as to improvement in display performance of a naked-eye stereoscopic image display device or a dual-screen display device.

Further,it is only necessary that the patterns of the common wires 201 and 204 be disposed only on two sides (the input-side connection area 52 and the counter-input-side connection area 56) of the first transparent substrate 21. Therefore, the frame area of the parallax barrier shutter panel 20 can be prevented from being extended.

[Modification]

FIG. 9 to FIG. 12 illustrate an example where the counter-input-side connection area 56 is formed using the lower-layer wires 71, the upper-layer wires 72, and the common wires 204 as metal wires. However, the counter-input-side connection area 56 can be formed without using metal wires.

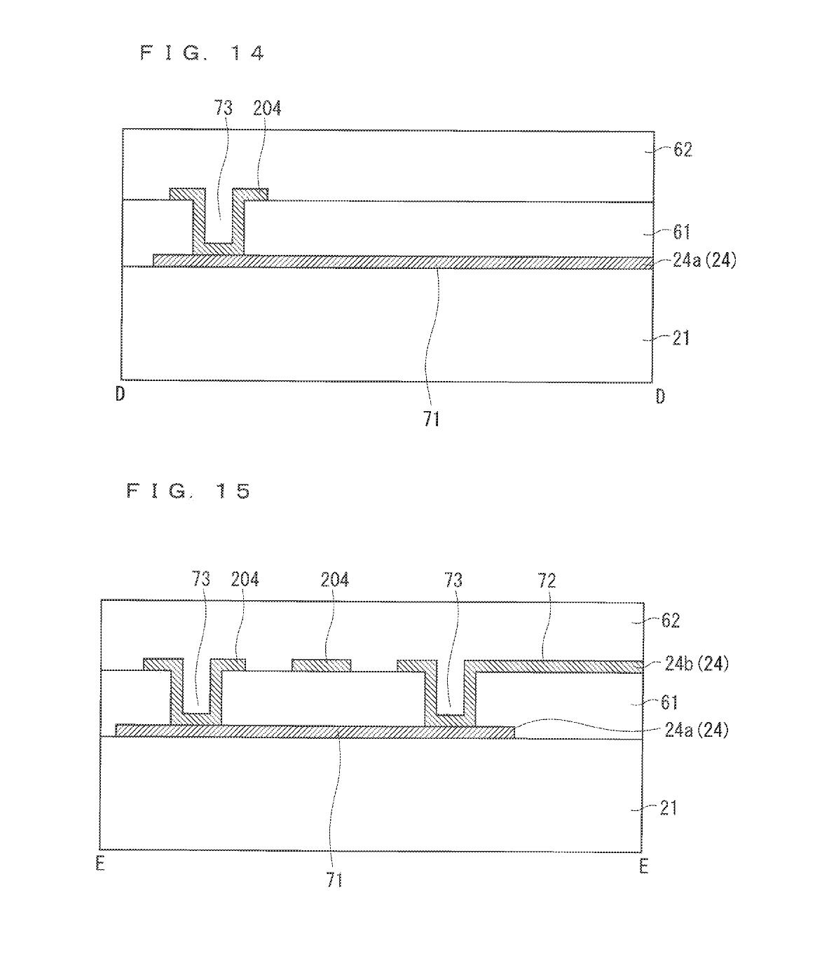

FIG. 13 to FIG. 15 illustrate an example where the counter-input-side connection area 56 is formed without using metal wires. FIG. 13 is a partial enlarged plan view of the counter-input-side connection area 56. FIG. 14 and FIG. 15 are cross-sectional views taken along the line D-D and the line E-F, illustrated in FIG. 13, respectively.

In contrast to the configuration of FIG. 9 to FIG. 12, the counter-input-side connection area 56 illustrated in FIG. 13 to FIG. 15 has a configuration in which the lower-layer wires 71 are formed using a transparent conductive film in the same layer as the lower-layer transparent electrodes 24a, and the upper-layer wires 72 and the common wires 204 are formed using a transparent conductive film in the same layer as the upper-layer transparent electrodes 24b.

As illustrated in FIG. 14, the lower-layer transparent electrodes 24a and the lower-layer wires 71 that are directly connected to the lower-layer transparent electrodes 24a are integrally formed, so as to be continuous. Further, as illustrated FIG. 15, the upper-layer transparent electrodes 24b and the upper-layer wires 72 that are directly connected to the upper-layer transparent electrodes 24b are integrally formed so as to he continuous. Further, the contact holes 73 provided in the interlayer insulation film 61 are formed so as to reach upper surfaces of the lower-layer wires 71, and the upper-layer wires 72 and the common wires 204 are connected to the lower-layer wires 71 through the contact holes 73. That is, the inside of the contact holes 73 in the upper-layer wires 72 and the common wires 204 serves as the connection wires 74 illustrated in FIG. 9 to FIG. 12.

The above description is given of a configuration in which the common wires 204 that connect the first transparent electrodes 24 receiving input of the same barrier control signal are disposed on the interlayer insulation film 61. However, the common wires 204 may be disposed below the interlayer insulation film 61 (on the first transparent substrate 21). That is, the common wires 204 may be formed using a metal film in the same layer as the lower-layer wires 71, or may be formed using a transparent conductive film in the same layer as the lower-layer transparent electrodes 24a.

Further, FIG. 10 to FIG. 12 illustrate a structure in which the lower-layer transparent electrodes 24a are disposed on the lower-layer wires 71 formed of a metal film, and the upper-layer transparent electrodes 24b are disposed on the upper-layer wires 72 formed of a metal film. However, the lower-layer transparent electrodes 24a and the upper-layer transparent electrodes 24b may be reversely disposed. That is, the lower-layer wires 71 formed of a metal an may be disposed on the lower-layer transparent electrodes 24a, and the upper-layer wires 72 formed of a metal film may be disposed on the upper-layer transparent electrodes 24b.

A material for the lower-layer transparent electrode 24a and the upper-layer transparent electrode 24b is only required to be optically transparent and conductive. Examples of such a material include, but are not limited to, indium zinc oxide (IZO) and indium tin oxide (ITO).

A material for the lower-layer wire 71 and the upper-layer wire 72 need not necessarily he transparent, and is only required to be conductive. A material having higher conductivity than that for the lower-layer transparent electrode 24a and the upper-layer transparent electrode 24b is preferable. Examples of such a material include, but are not limited to, a metal material such as Al, Cu, Ni, Ag, Nd, Mo, Nb, W, Ta, and Ti.

A material for the interlayer insulation film 61 and the protective insulation film 62 is only required to be transparent and electrically insulated. Examples of such a material include, but are not limited to, a SiN film, a SiO film, an inorganic insulation film such as a laminated film of SiN and SiO, and an organic insulation film mainly containing an optically transparent acrylic material.

### Second Preferred Embodiment

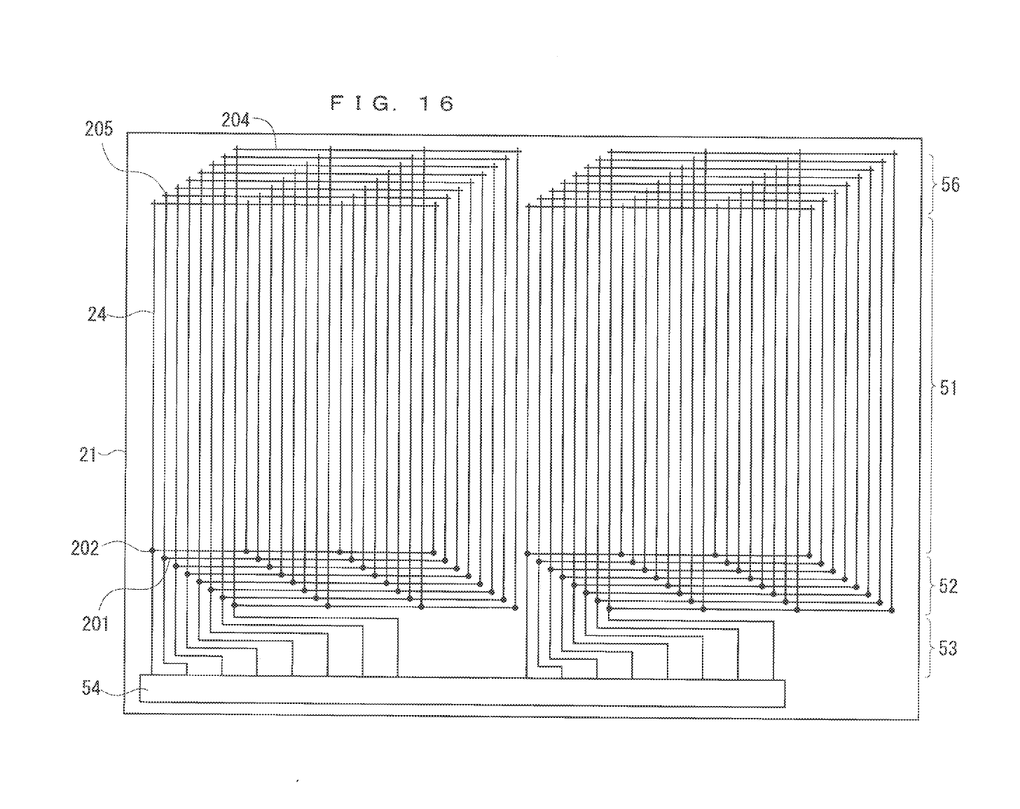

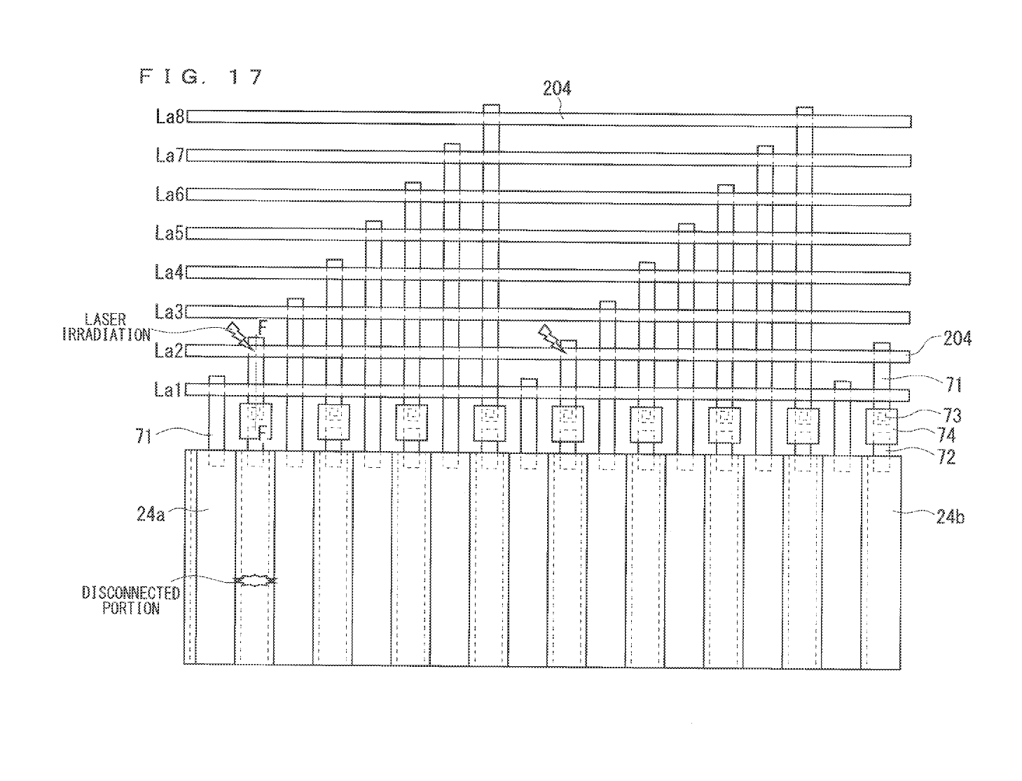

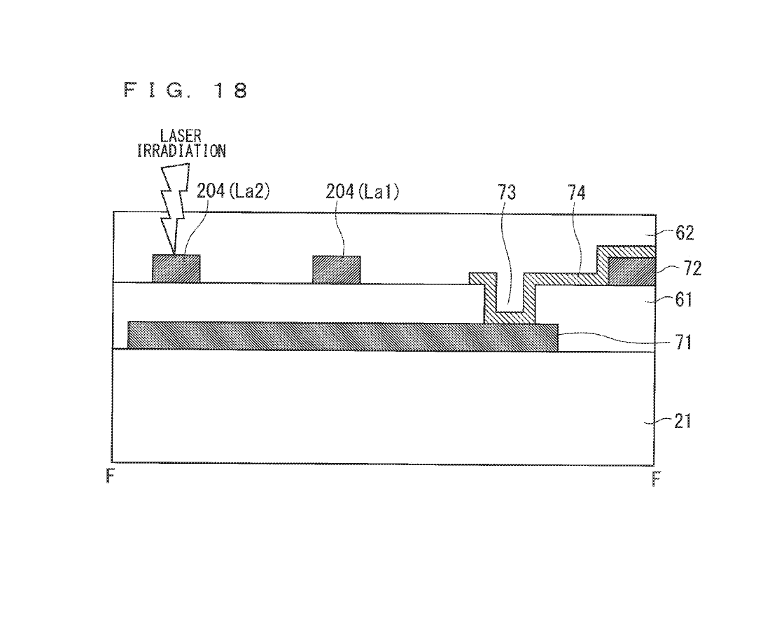

FIG. 16 is a plan view illustrating an overall configuration of the first transparent substrate 21 of the parallax bather shutter panel 20 according to a second preferred embodiment. FIG. 17 is a partial enlarged plan view of the counter-input-side connection area 56 of the first transparent substrate 21 of the parallax barrier shutter panel 20 according to the second preferred embodiment. FIG. 18 is a cross-sectional view taken along the line F-F illustrated in FIG. 17.

As illustrated in FIG. 6 and FIG. 9, in the counter-input-side connection area 56 according to the first preferred embodiment, the first transparent electrodes 24 (the lower-layer transparent electrodes 24a and the upper-layer transparent electrodes 24b) that receive input of the same barrier control signal are electrically connected one another via the common wires 204. In contrast, in the second preferred embodiment, as in FIG. 16 and FIG. 17, the first transparent electrodes 24 (the lower-layer transparent electrodes 24a and the upper-layer transparent electrodes 24b) and the common wires 204 are not connected, and the common wires 204 are floated. Note that, similarly to the first preferred embodiment, the number of the common wires 204 to be provided in a single common drive area is equal to the number of the barrier control signals.

Further, at distal ends of the first transparent electrodes 24, cross portions 205 are formed, which are intersecting points where the first transparent electrodes 24 and the common wires 204 sterically intersect each other. When the cross portion 205 is irradiated with a laser, the first transparent electrode 24 and the common wire 204 intersecting at the cross portion 205 can be connected. Note that, the portions in FIG. 17 where distal ends of the lower-layer wires 71 and the common wires 204 intersect each other correspond to the cross portions 205 illustrated in FIG. 16.

For example, as in FIG. 17, if one of upper-layer transparent electrodes 24b that receive input of a barrier control signal La2 is disconnected, a repair treatment is performed. Specifically, two portions, that is, a cross portion of the disconnected upper-layer transparent electrode 24b and the common wire 204 and a cross portion of another upper-layer transparent electrode 24b that receives input of the barrier control signal La2 and the common wire 204, are irradiated with a laser. Through this repair treatment, the disconnected upper-layer transparent electrode 24b receives input of the barrier control signal La2 from both ends. As a result, the barrier control signal is supplied to the disconnected first transparent electrode 24 further beyond the disconnected portion, thus allowing the parallax barrier to operate correctly.

[Modification]

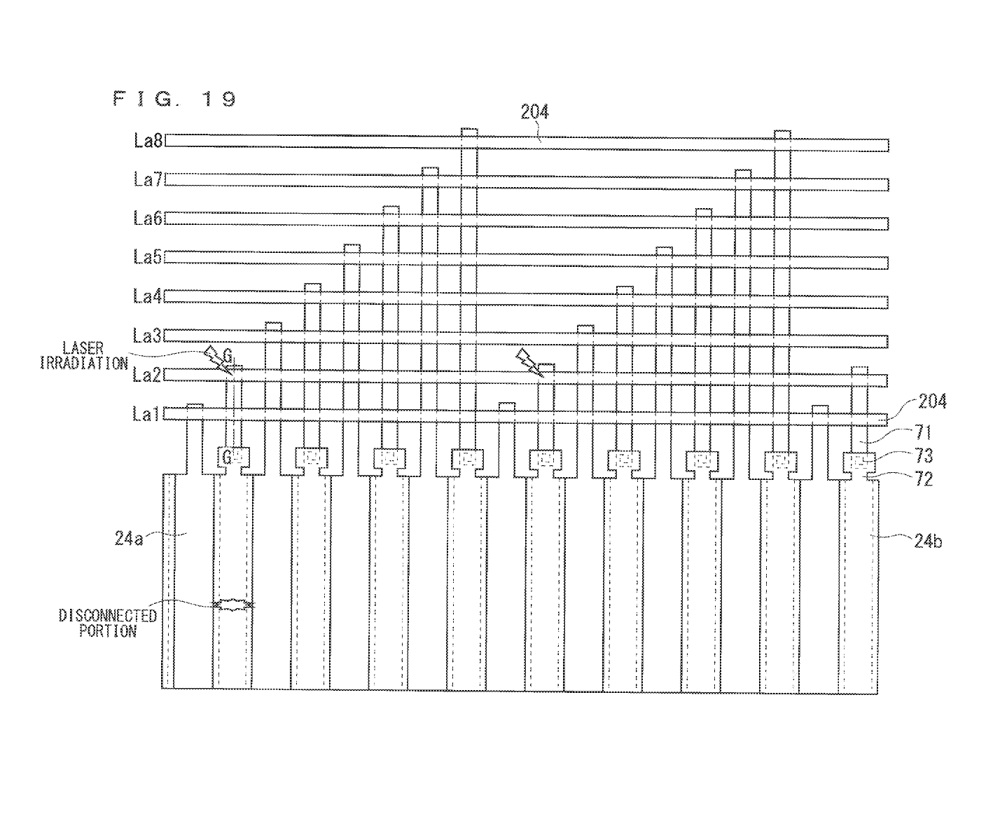

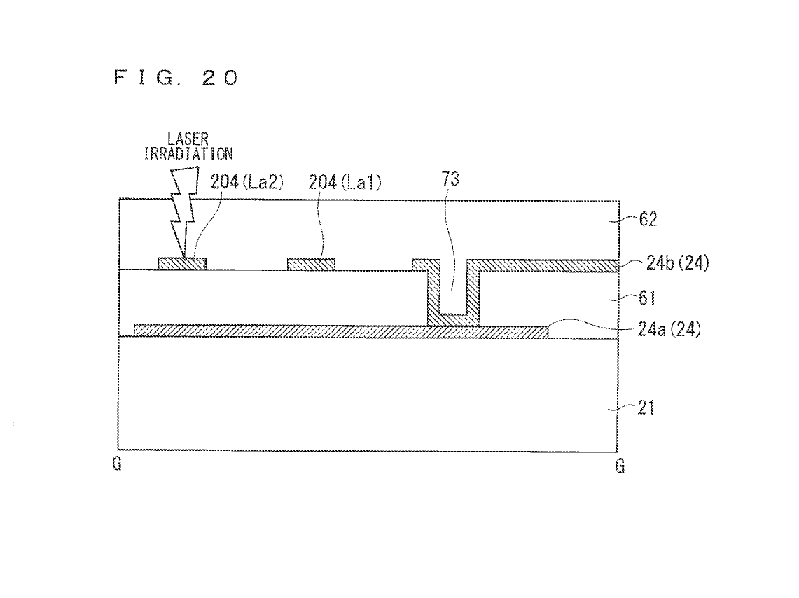

Also in the second preferred embodiment, the counter-input-side connection area 56 can be formed without using metal wires. FIG. 19 and FIG. 20 illustrate an example where the counter-input-side connection area 56 is formed without using metal wires. FIG. 19 is a partial enlarged plan view of the counter-input-side connection area 56. FIG. 20 is a cross-sectional view taken along the line G-G illustrated in FIG. 19.

In contrast to the configuration of FIG. 13 to FIG. 15, the counter-input-side connection area 56 illustrated in FIG. 19 and FIG. 20 has a configuration in which the lower-layer wires 71 are formed using a transparent conductive film in the same layer as the lower-layer transparent electrodes 24a, and the upper-layer wires 72 and the common wires 704 are formed using a transparent conductive film in the same layer as the upper-layer transparent electrodes 24b.

The configuration of the counter-input-side connection area 56 illustrated in FIG. 19 and FIG. 20 is basically similar to that of FIG. 13 to FIG. 15; however, the lower-layer wires 71 and the common wires 204 are not connected, and the common wires 204 are floated. Further, at distal ends of the lower-layer wires 71, cross portions are formed, where the lower-layer wires 71 and the common wires 204 sterically intersect each other. When the cross portion is irradiated with a laser, a repair treatment of connecting the lower-layer wire 71 and the common wire 204 intersecting at the cross portion can be implemented. Thus, the effects of the second preferred embodiment can be attained.

Further, connection resistance (connection resistance between the lower-layer wire 71 and the common wire 204) at the repair portion can be stabilized by depositing low-resistance metal, such as tungsten (W), on the repair portion with use of a laser chemical vapor deposition (CVD) repair device or the like during the repair treatment. Examples of a material to be deposited with a laser CVD repair device include, but not limited to, a metal material such as Al, Cu, Ni, Ag, Nd, Mo, Nb, W, Ta, and Ti.

Similarly to the counter-input-side connection area 56, the input-side connection area 52 and the wire area 53 may be formed without using metal wires as well.

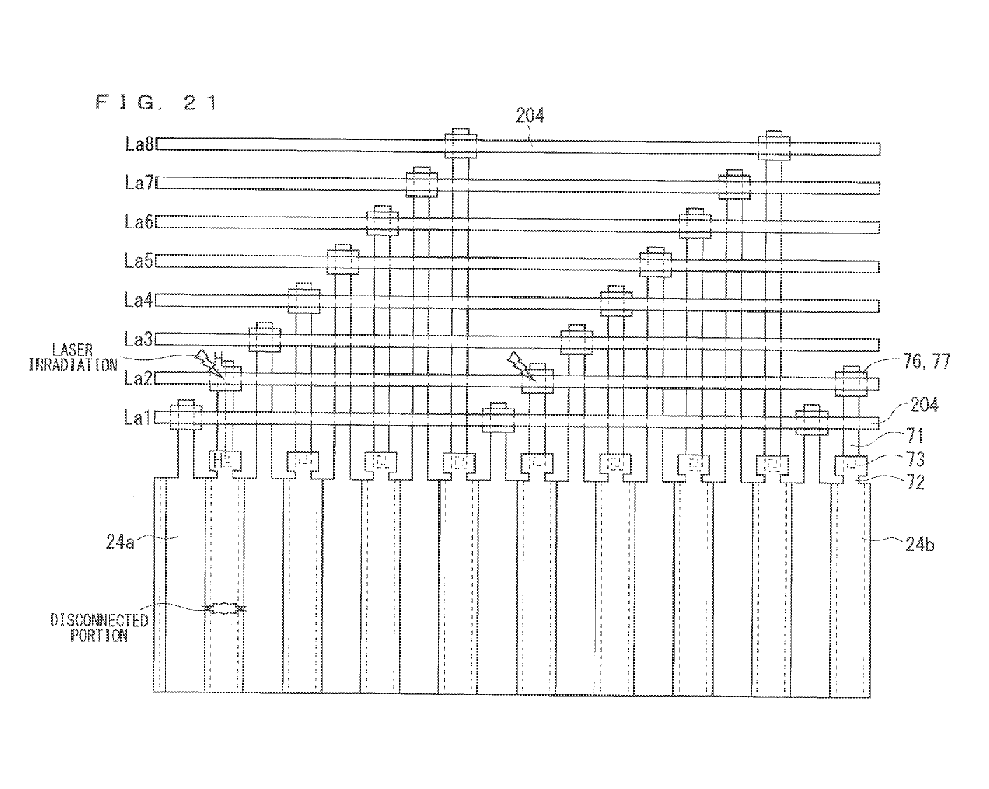

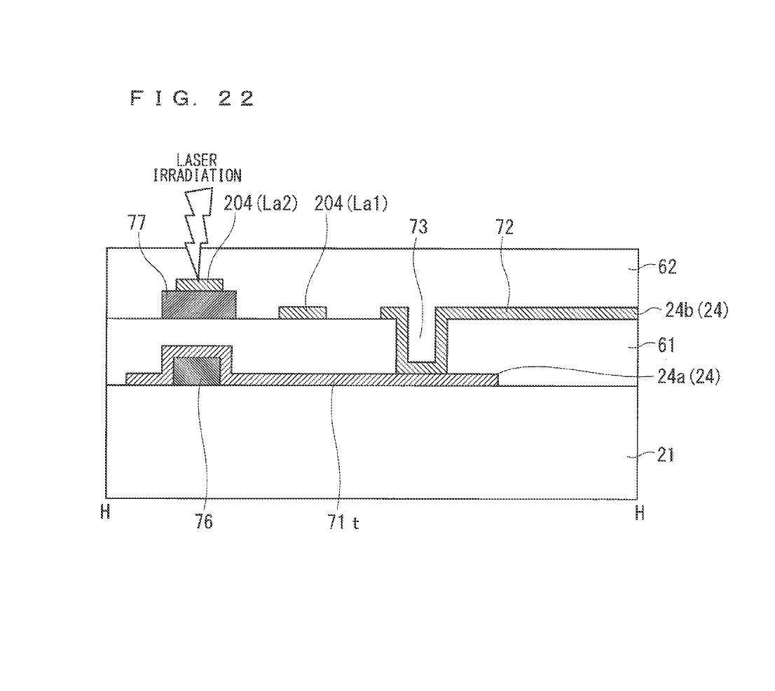

Further, as illustrated in FIG. 21 and FIG. 22 (a cross-sectional view taken along the line H-H of FIG. 21), metal films 76 and 77 may be respectively provided below the lower-layer wire 71 and below the common wire 204 at the cross portion of the lower-layer wire 71 and the common wire 204. With this, connection resistance at the repair portion is stabilized when the cross portion is subjected to a repair treatment with laser irradiation. The both of the metal film 76 below the lower-layer wire 71 and the metal film 77 below the common wire 204 need not necessarily be provided together, and only either of the two may be provided.

Also in the second preferred embodiment, description is given of a configuration in which the common wires 204 that connect the first transparent electrodes 24 receiving input of the same: barrier control signal are disposed on the interlayer insulation film 61. However, the common wires 204 may be disposed below the interlayer insulation film 61 (on the first transparent substrate 21). That is, the common wires 204 may be formed using a metal film in the same layer as the lower-layer wires 71, or may be formed using a transparent conductive film in the same layer as the lower-layer transparent electrodes 24a. In such a case, a portion where the common wire 204 below the interlayer insulation film 61 and a distal end of the upper-layer wire 72 on the interlayer insulation film 61 sterically intersect each other corresponds to a cross portion. Such holds true for the common wire 201 of the input-side connection area 52.

### Third Preferred Embodiment

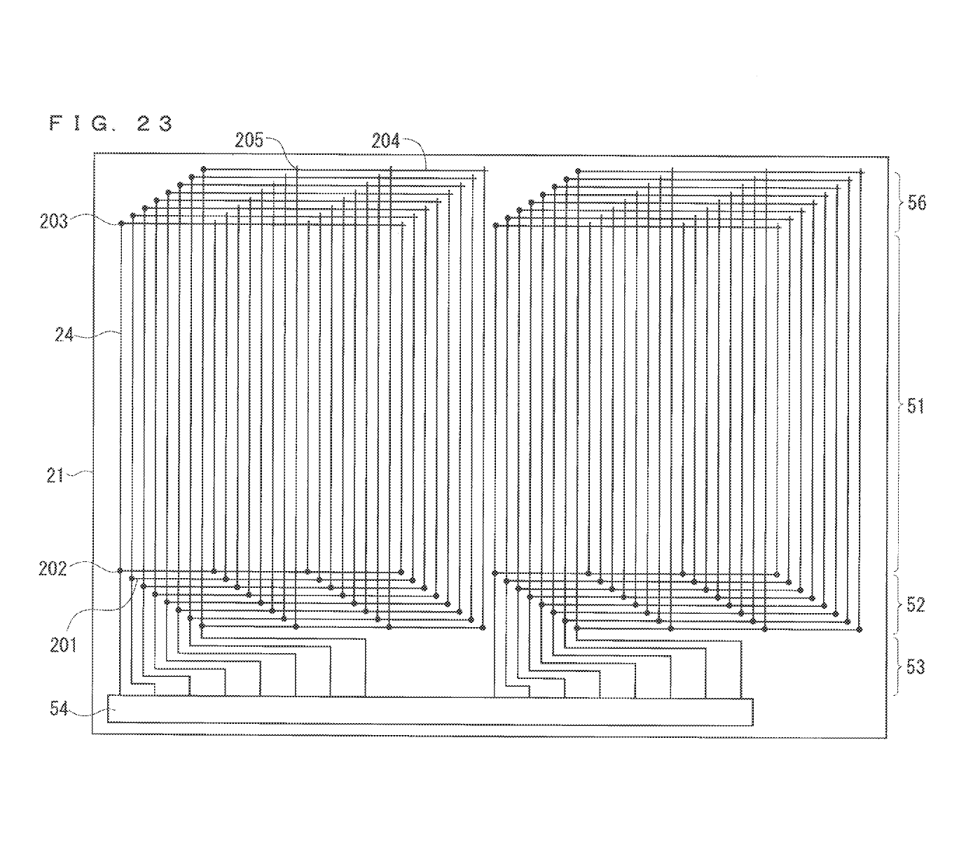

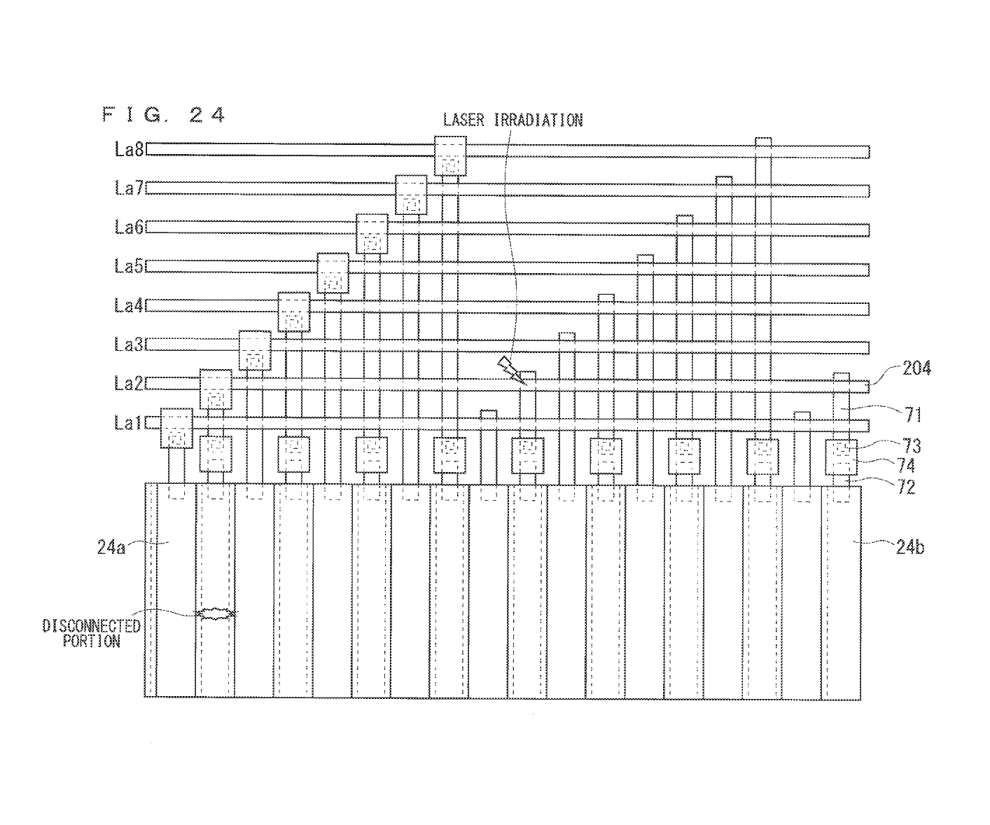

FIG. 23 is a plan view illustrating an overall configuration of the first transparent substrate 21 of the parallax barrier shutter panel 20 according to a third preferred embodiment. FIG. 24 is a partial enlarged plan view of the counter-input-side connection area 56 of the first transparent substrate 21 of the parallax barrier shutter panel 20 according to the third preferred embodiment.

In the above second preferred embodiment, the common wires 204 disposed in the counter-input-side connection area 56 are not connected to any of the first transparent electrodes 24 (the lower-layer transparent electrodes 24a and the upper-layer transparent electrodes 24b) so as to be floated. In the third preferred embodiment, however, at least one first transparent electrode 24 is connected to each common wire 204.

The first transparent electrodes 24 that are connected to different common wires 204 receive input of different barrier control signals. Thus, each common wire 204 is supplied with a different barrier control signal via at least one first transparent electrode 24. Further, the cross portions 205 irradiated with a laser during a repair treatment are portions where the first transparent electrodes 24 supplied with the same barrier drive signal and the common wires 204 sterically intersect each other.

In the third preferred embodiment, the common wire 204 is connected to at least one first transparent electrode 24. Therefore, for example, if the first transparent electrode 24 is disconnected as in FIG. 24, the barrier control signal can be supplied further to a portion beyond the disconnected portion only by irradiating one cross portion with a laser, thus allowing the parallax barrier to operate correctly. Thus, the number of portions required to be irradiated with a laser can be decreased as compared to that in the second preferred embodiment, and repair efficiency can be increased.

Also in the third preferred embodiment, the counter-input-side connection area 56 can be formed without using metal wires. Further, the common wires 204 that connect the first transparent electrodes 24 receiving input of the same barrier control signal may be disposed below the interlayer insulation film 61 (on the first transparent substrate 21). The above described matters hold true for the input-side connection area 52 and the wire area 53.

### Fourth Preferred Embodiment

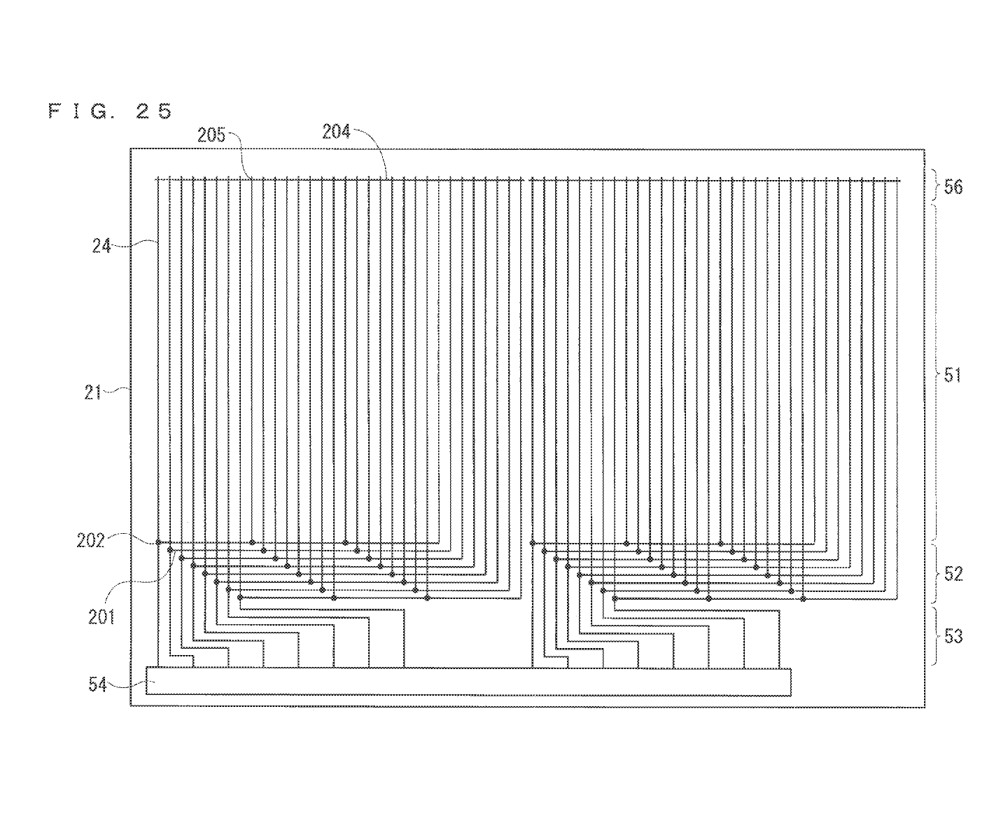

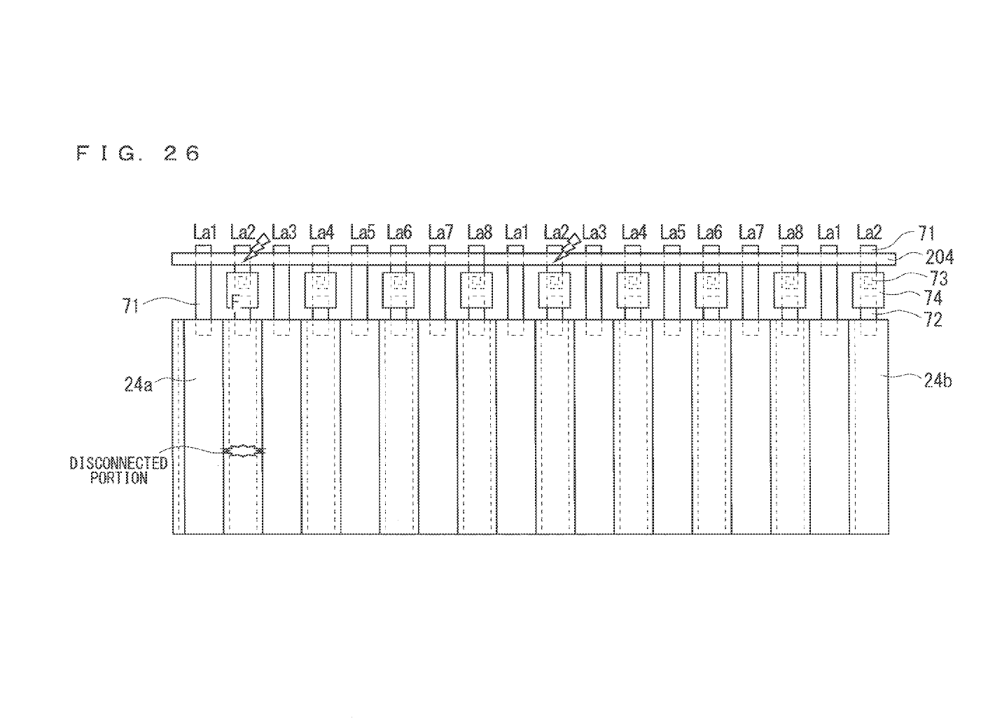

FIG. 25 is a plan view illustrating an overall configuration of the first transparent substrate 21 of the parallax barrier shutter panel 20 according to a fourth preferred embodiment. FIG. 26 is a partial enlarged plan view of the counter-input-side connection area 56 of the first transparent substrate 21 of the parallax barrier shutter panel 20 according to the fourth preferred embodiment.

In the above second preferred embodiment, the number of the common wires 204 to be provided in a single common drive area is equal to the number of the barrier control signals. In the fourth preferred embodiment, however, the number of the common wires 204 is smaller than the number of the barrier control signals. That is, the number of the common wires 204 per common drive area is equal to or more than one and equal to or less than the number of the barrier control signals minus one. Further, the common wires 204 are not connected to any of the first transparent electrodes 24 (the lower-layer transparent electrodes 24a or the upper-layer transparent electrodes 24b) so as to be floated.

FIG. 25 and FIG. 26 illustrate an example where a single common wire 204 is provided per common drive area. In this case, the common wire 204 and all of the first transparent electrodes 24 (the lower-layer transparent electrodes 24a or the upper-layer transparent electrodes 24b) in the common drive area conjointly form the cross portions 205. That is, the common wire 204 can be connected to any first transparent electrode 24 by laser irradiation at the cross portion 205,.

For example, as in FIG. 26, if one of upper-layer transparent electrodes 24b that receive input of a barrier control signal La2 is disconnected, a repair treatment is performed. Specifically, two portions, that is, a cross portion of the disconnected upper-layer transparent electrode 24b and the common wire 204 and a cross portion of another upper-layer transparent electrode 24b that receives input of the barrier control signal La2 and the common wire 204, are irradiated with a laser. Through this repair treatment, the disconnected upper-layer transparent electrode 24b receives input of the barrier control signal La2 from both ends. As a result, the barrier control signal is supplied to the disconnected first transparent electrode 24 further beyond the disconnected portion, thus allowing the parallax barrier to operate correctly.

The number of disconnected wires that can be subjected to a repair treatment is decreased as compared to that of the first to third preferred embodiments since a single disconnected wire can be subjected to a repair treatment per common wire 204. However, the frame area can he narrowed correspondingly to the decreased number of the common wires 204 disposed in the counter-input-side connection area 56.

Further, in this preferred embodiment, which barrier control signal is to be supplied to each of the common wires 204 (which first transparent electrode 24 is to be connected to each of the common wires 204) varies depending on which first transparent electrode 24 is disconnected. Further, the cross portions are located at positions aligned in the length direction of the first transparent electrodes 24 as in FIG. 26, and accordingly it is difficult to determine which cross portion is to be irradiated with a laser during a repair treatment. As a countermeasure, if marks such as “La1,” “La2,” and “La3” are attached close to respective cross portions in advance as identification symbols for barrier control signals being supplied to the first transparent electrodes 24 that correspond to the respective cross portions, determining which cross portion is to be irradiated with a laser is facilitated.

Also in the fourth preferred embodiment, the counter-input-side connection area 56 can be formed without using metal wires. Further, the common wires 204 that connect the first transparent electrodes 24 receiving input of the same barrier control signal may be disposed below the interlayer insulation film 61 (on the first transparent substrate 21). Such holds true for the input-side connection area 52 and the wire area 53.

Note that, in the present invention, each of the preferred embodiments may be freely combined, and each of the preferred embodiments may be modified or omitted as appropriate within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. An image display device comprising:
a display panel in which a plurality of sub-pixel pairs are horizontally disposed at predetermined pitches_{;} the plurality of sub-pixel pairs each comprising two sub-pixels that display different images; and
a parallax barrier shutter panel in which a plurality of sub-apertures are horizontally disposed, the plurality of sub-apertures being capable of being switched between a light-transmission state and a light-shielding state by driving a liquid crystal layer held between a first transparent substrate and a second transparent substrate with a plurality of vertically extending transparent electrodes,
the display panel and the parallax barrier shutter panel being disposed in a stacked manner in the image display device,
the first transparent substrate of the parallax barrier shutter panel comprising:
in a display area, a plurality of lower-layer transparent electrodes disposed below an interlayer insulation film and a plurality of upper-layer transparent electrodes disposed on the interlayer insulation film as the plurality of transparent electrodes;
in a first area adjacent to the display area, a wire for inputting a barrier control signal that is output from a drive circuit into the plurality of transparent electrodes, the barrier control signal being for controlling the parallax barrier shutter panel; and
in a second area adjacent to the display area on an opposite side to the first area with respect to the display area, a common wire for connecting transparent electrodes that receive input of the same barrier control signal among the plurality of transparent electrodes.

2. The image display device according to claim 1, wherein
the common wire comprises a plurality of common wires, and the number of the plurality of common wires is equal to the number of the barrier control signals.

3. The image display device according to claim 1, wherein
the plurality of transparent electrodes and the common wire are formed between the first transparent substrate and the second transparent substrate.

4. The image display device, according to claim 2, wherein
the plurality of transparent electrodes and the common wire are formed between the first transparent substrate and the second transparent substrate.

5. An image display device comprising:
a display panel in which a plurality of sub-pixel pairs are horizontally disposed at predetermined pitches, the plurality of sub-pixel pairs each comprising two sub-pixels that display different images; and
a parallax barrier shutter panel in which a plurality of sub-apertures are horizontally disposed, the plurality of sub-apertures being capable of being switched between a light-transmission state and a light-shielding state by driving a liquid crystal layer held between a first transparent substrate and a second transparent substrate with a plurality of vertically extending transparent electrodes,
the display panel and the parallax barrier shutter panel being disposed in a stacked manner in the image display device,
the first transparent substrate of the parallax barrier shutter panel comprising:
in a display area, a plurality of lower-layer transparent electrodes disposed below an interlayer insulation film and a plurality of upper-layer transparent electrodes disposed on the interlayer insulation film as the plurality of transparent electrodes;
in a first area adjacent to the display area, a wire for inputting a barrier control signal that is output from a drive circuit into the plurality of transparent electrodes, the barrier control signal being for controlling the parallax barrier shutter panel; and
in a second area adjacent to the display area on an opposite side to the first area with respect to the display area, at least one common wire that sterically intersects with the plurality of transparent electrodes,
the common wire being capable of being connected to any of the plurality of transparent electrodes by laser irradiation at an intersecting point between the common wire and the plurality of transparent electrodes.

6. The image display device according to claim 5, wherein
the common wire comprises a plurality of common wires, and the number of the plurality of common wires is equal to the number of the barrier control signals.

7. The image display device according to claim 6, wherein
the plurality of common wires are floated.

8. The image display device according to claim 6, wherein
each of the plurality of common wires is connected to at least one of the transparent electrodes, and
the plurality of common wires are supplied with the respective barrier control signals via the at least one of the transparent electrodes, the respective barrier control signals being different from one another,

9. The image display device according to claim 5, wherein
the number of the common wires is smaller than the number of the barrier control signals.

10. The image display device according to claim 9, wherein
the plurality of common wires are floated.

11. The image display device according to claim 9, wherein
the common wire is capable of being connected to any transparent electrode among the plurality of transparent electrodes by laser irradiation at an intersecting point between the common wire and the plurality of transparent electrodes.

12. The image display device according to claim 10, wherein
the common wire is capable of being connected to any transparent electrode among the plurality of transparent electrodes by laser irradiation at an intersecting point between the common wire and the plurality of transparent electrodes.

13. The image display device according to claim 5, wherein.
the plurality of transparent electrodes and the common wire are formed between the first transparent substrate and the second transparent substrate.

14. The image display device according to claim 6, wherein the plurality of transparent electrodes and the common wire are formed between the first transparent substrate and the second transparent substrate.

15. The image display device according to claim 7, wherein
the plurality of transparent electrodes arid the common wire are formed between the first transparent substrate and the second transparent substrate.

16. The image display device according to claim 8, wherein
the plurality of transparent electrodes and the common wire are formed between the first transparent substrate and the second transparent substrate.

17. The image display device according to claim 9, wherein
the plurality of transparent electrodes and the common wire are formed between the first transparent substrate and the second transparent substrate.

18. The image display device according to claim 10, wherein
the plurality of transparent electrodes and the common wire are formed between the first transparent substrate and the second transparent substrate.

19. The image display device according to claim 11, wherein
the plurality of transparent electrodes and the common wire are formed between the first transparent substrate and the second transparent substrate.

20. The image display device according to claim 12, wherein
the plurality of transparent electrodes and the common formed between the first transparent substrate and the second transparent substrate.
